(19) United States
(12) Patent Application Publication
(10) Pub. No.: US 2017/0211830 A1
(43) Pub. Date: Jul. 27, 2017

(54) AIR-CONDITIONING CONTROL SYSTEM, AIR-CONDITIONING PLANNING DEVICE, AND PLANNING METHOD

(71) Applicant: HITACHI INFORMATION & TELECOMMUNICATION ENGINEERING, LTD., Yokahama-shi (JP)

(72) Inventors: Tadayoshi KOSAKA, Tokyo (JP); Nobuhiro MATSUDAIRA, Yokohama (JP); Isao KOBAYASHI, Yokohama (JP); Yasutaka SATAKE, Yokohama (JP); Kazuhiko KOYANAGI, Yokohama (JP)

(73) Assignee: HITACHI INFORMATION & TELECOMMUNICATION ENGINEERING, LTD., Yokohama-shi (JP)

(21) Appl. No.: 15/375,233

(22) Filed: Dec. 12, 2016

(30) Foreign Application Priority Data
Jan. 25, 2016 (JP) 2016-011567

(51) Int. Cl. F24F 11/00; G05B 19/048

(52) U.S. Cl. CPC F24F 11/006; F24F 11/0012; G05B 19/048; F24F 2011/0063; F24F 2011/0047; F24F 2011/0013; F24F 2011/0049; F24F 2011/0058; F24F 2011/0064; F24F 2011/0075; G05B 2219/2614

(57) ABSTRACT

An air-conditioning planning unit: obtains air-conditioning control plan options indicating setting values for air-conditioning, a first room temperature of a space at a first control time, and a first air-conditioning power usage consumed at the first control time; calculates a second room temperature at a second control time with a first function whose explanatory variables include the first room temperature, the first air-conditioning power usage, and at least one of the options; calculates, for each of the options, room temperature and air-conditioning power usage in a time series by calculating a second air-conditioning power usage at the second control time with a second function whose explanatory variables include the first room temperature, the first air-conditioning power usage, and at least one of the options; calculates an evaluation indicator to evaluate a comfort level and cost; and selects an air-conditioning control plan from the options based on the evaluation indicator.

### CLAIM OF PRIORITY

The present application claims priority from Japanese patent application JP 2016-011567 filed on Jan. 25, 2016, the content of which is hereby incorporated by reference into this application.

### BACKGROUND OF THE INVENTION

The present invention relates to an air-conditioning control system, an air-conditioning planning device, and a planning method.

An air-conditioning unit has a function of monitoring a room temperature and adjusting an output so as to maintain the preset temperature. It is known that the efficiency of an air-conditioning unit greatly varies depending on the output thereof, and in some cases, the power consumption can be reduced by intermittently operating the unit with limited operation time rather than operating continuously in an automatic mode. The efficiency of an air-conditioning unit changes in a complex manner due to various factors, such as outside temperature, room temperature set-point, and humidity, and it is difficult to perfectly control the unit to minimize the power consumption.

To solve this problem, an air-conditioning energy evaluation system having a means to calculate a thermal load of a building through building thermal load simulation and a means to calculate an optimal target value that saves energy and cost through air-conditioning system simulation using operation control parameters of the air-conditioning system is proposed (see JP-2005-090780 A, for example).

### SUMMARY OF THE INVENTION

In order to achieve the air-conditioning energy evaluation system of JP-2005-090780 A, it is necessary to build a building air-conditioning model by modeling the building and air-conditioning system using parameters, such as the structure of the building including wall surfaces, ceilings, floors and windows, as well as the material, size, quantity and orientation. However, those parameters would change whenever a change is made to the installation environment, installation location, and the like, and in that case, a new building air-conditioning model needs to be constructed by an engineer specialized in the field.

Specifically, when the layout or purpose of the building changes, or when the air-conditioning unit is updated or modified, the building air-conditioning model needs to be constructed again by an engineer. This means that an engineer having deep knowledge in construction and air-conditioning equipment is required to both build and maintain an air-conditioning system, and a burden on the engineer would increase. This makes it difficult to implement the method using a building air-conditioning model.

To solve the above problem, the present invention includes An air-conditioning system that controls air-conditioning of a space, comprising: an air-conditioning planning unit configured to generate a control plan for the air conditioning; and an air-conditioning control unit configured to control the air-conditioning, wherein the air-conditioning planning unit has a processor and a memory, wherein the air-conditioning planning unit is connected to the air-conditioning control unit, and wherein the air-conditioning planning unit is configured to: obtain and store, in the memory, a plurality of air-conditioning control plan options indicating setting values for the air-conditioning at a plurality of control times at which the air-conditioning is controlled, a first room temperature of the space at a first control time included in the plurality of control times, and a first air-conditioning power usage consumed at the first control time; store, in the memory, the plurality of air-conditioning control plan options, the first room temperature, and the first air-conditioning power usage; calculate, for each of the options, a second room temperature at a second control time, which is a control time subsequent to the first control time, by using a room temperature calculation function whose explanatory variables include the first room temperature, the first air-conditioning power usage, and at least one of the options; calculate, for each of the options, room temperature and air-conditioning power usage in a time series that includes the plurality of control times by calculating a second air-conditioning power usage at the second control time with an air-conditioning power usage calculation function whose explanatory variables include the first room temperature, the first air-conditioning power usage, and at least one of the options; store the room temperature and air-conditioning power usage in a time series that includes the plurality of control times in the memory; calculate, for each of the options, an evaluation indicator to evaluate a level of comfort and cost, based on the room temperature in a time series and the air-conditioning power usage in a time series; select an air-conditioning control plan to be applied to the air-conditioning control unit from the plurality of options based on the evaluation indicator; and send the selected air-conditioning control plan to the air-conditioning control unit so that the air-conditioning is controlled in accordance with the selected air-conditioning control plan.

According to the present invention, it is possible to create a plan for the optimal air-conditioning operation without an expert. The problems, configurations, and effects other than those described above will become apparent by the descriptions of embodiments below.

### BRIEF DESCRIPTIONS OF DRAWINGS

The present invention can be appreciated by the description which follows in conjunction with the following figures, wherein:

FIG. 1 is a block diagram showing an example of a device configuration and a communication network configuration of Embodiment 1;

FIG. 2 is a block diagram showing a physical configuration of an air-conditioning planning device of Embodiment 1;

FIG. 3 is an explanatory diagram showing a schedule on which the air-conditioning planning device of Embodiment 1 conducts processing;

FIG. 4 is a flow chart showing air-conditioning control plan generation processing conducted by the air-conditioning planning device of Embodiment 1;

FIG. 5 is an explanatory diagram showing an example of time data generated in a generation of control plan of Embodiment 1;

FIG. 6 is an explanatory diagram showing an example of time data generated in re-planning of Embodiment 1;

FIG. 7 is an explanatory diagram showing weather forecast data of Embodiment 1;

FIG. 8 is an explanatory diagram showing building forecast data of Embodiment 1;

FIG. 9 is an explanatory diagram showing outside temperature, actual frame temperature, and approximate frame temperature of Embodiment 1;

FIG. 10 is a flowchart showing processing to calculate frame temperature in Embodiment 1;

FIG. 11 is an explanatory diagram showing an air-conditioning control plan option for summer of Embodiment 1;

FIG. 12 is an explanatory diagram showing an air-conditioning control plan option for intermediate periods (spring and autumn) of Embodiment 1;

FIG. 13 is an explanatory diagram showing an air-conditioning control plan option for winter in Embodiment 1;

FIG. 14 is an explanatory diagram showing procedures to calculate room temperature RT[i] and air-conditioning power usage AP[i] of Embodiment 1;

FIG. 15 is a flowchart showing processing to generate a room temperature calculation procedure and an air-conditioning power usage calculation procedure of Embodiment 1;

FIG. 16 is an explanatory diagram showing an example of a screen of Embodiment 1;

FIG. 17 is a block diagram showing an example of a device configuration and a communication network configuration of Embodiment 2;

FIG. 18 is a flowchart showing air-conditioning control plan generation processing by the air-conditioning planning device 1 of Embodiment 2;

FIG. 19 is an explanatory diagram showing an air-conditioning control plan option for intermediate periods of Embodiment 2;

FIG. 20 is a block diagram showing an example of a device configuration and a communication network configuration of Embodiment 3;

FIG. 21 is an explanatory diagram showing an air-conditioning control plan option of Embodiment 3; and

FIG. 22 is a flowchart showing in detail processing to generate a room temperature calculation procedure and an air-conditioning power usage calculation procedure of Embodiment 3.

### DETAILED DESCRIPTION OF THE PREFERRED EMBODIMENTS

Below, embodiments of the present invention are explained with reference to the appended figures.

### Embodiment 1

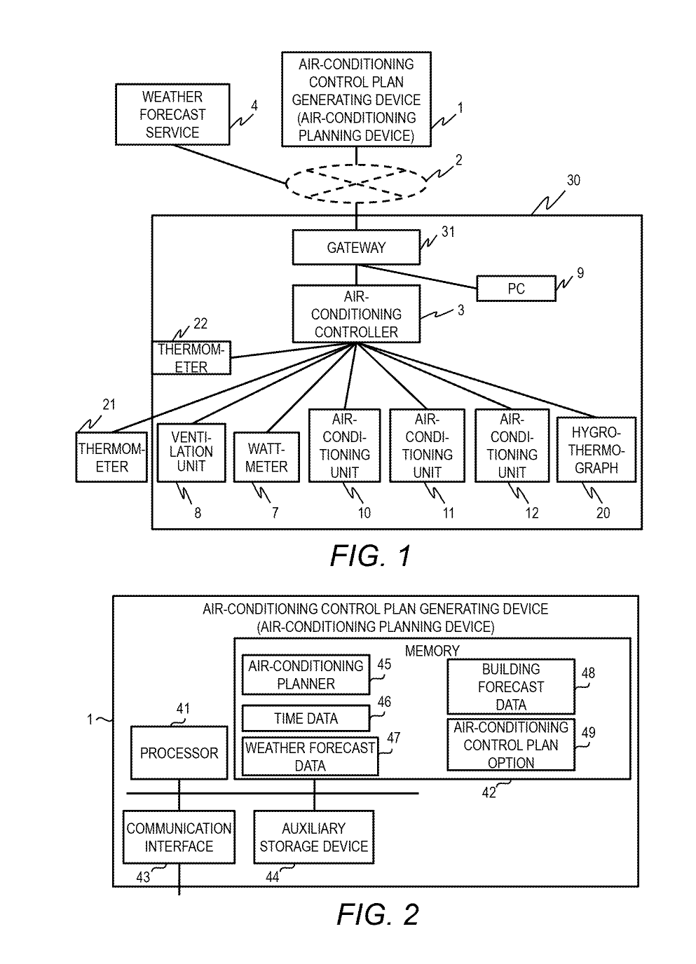

FIG. 1 is a block diagram showing an example of the device configuration and the communication network configuration of Embodiment 1.

An air-conditioning control system and an air-conditioning control plan generating device 1 are shown in the block diagram of FIG. 1. The air-conditioning control system of Embodiment 1 controls the air-conditioning in the internal space of a building 30. The building 30 may be large facility, such as a shopping mall or a complex, or another type of facility, such as a warehouse. A target space of the air-conditioning control system does not have to be completely enclosed in the building 30, and the building 30 may have an opening on any wall or the like thereof.

The air-conditioning system includes an air-conditioning controller 3, thermometers 21 and 22, a ventilation unit 8, a wattmeter 7, air-conditioning units (air-conditioners, for example) 10, 11, 12, and a hygro-thermometer 20.

The air-conditioning controller 3 is connected to the air-conditioning control plan generating device (air-conditioning planning device) 1 via a gateway 31 and a communication network 2. The air-conditioning planning device 1 is connected to a weather forecast service 4 and the gateway 31 via a closed network using optical communication or the communication network 2 using the Internet. The air-conditioning planning device 1 is connected to the air-conditioning controller 3 and a PC 9 via the gateway 31.

The air-conditioning planning device 1 is connected to the weather forecast service 4 via the communication network 2. The air-conditioning planning device 1 is connected to the PC 9 via the communication network 2 and the gateway 31.

The air-conditioning controller 3 is a device to control the air-conditioning of the space inside of the building 30 using an HVAC (heating, ventilation, and air-conditioning) unit. The air-conditioning controller 3 controls the air-conditioning of the space inside of the building 30 by controlling the air-conditioning units 10, 11, and 12 and the ventilation unit 8 based on values measured by the thermometer 21, the thermometer 22, the wattmeter 7, the hygro-thermometer 20, and the like.

The air-conditioning controller 3 may also be connected to the building 30, or a device configured to measure the physical amounts (sunlight level, UV level, and the like) around the building 30, in addition to the thermometer 21 and the like.

The thermometer 21 measures the outside temperatures of the building 30 itself. The hygro-thermometer 20 measures the room temperature and humidity inside of the building 30.

The thermometer 22 is installed in at least one of walls, water storage tanks, floors, and ceilings of the building 30, and measures frame temperature. The frame temperature is a temperature that changes in accordance with atmosphere temperature (including outside temperature) and that affects the air-conditioning control of the building 30.

In this embodiment, the frame is an object that affects the degree of comfort (environment) in a space in the building 30 that is subjected to the air-conditioning control. Examples of the frame include the building 30 itself, and a water storage tank, pool and the like in the building 30.

The ventilation unit 8 is a device that circulates the air in and out of the building 30. The wattmeter 7 measures the power consumed in the building 30. The air-conditioning units 10, 11, and 12 are configured to adjust the temperature and the humidity inside the building 30.

The PC 9 is a computer including a processor, a memory, an input device, and an output device and may be installed inside or outside of the building 30. The PC 9 enters, in the air-conditioning planning device 1, instructions received from an administrator or a user (is simply referred to as an operator below) through the input device. The PC 9 also outputs the processing results of the air-conditioning planning device 1 to an operator through the output device.

For example, the input device is a keyboard, mouse, or the like, and the output device is a printer or a display. The PC 9 may be a tablet device.

The gateway 31 may be installed inside or outside of the building 30. The gateway 31 relays the communication between the air-conditioning controller 3 and the air-conditioning planning device 1.

The weather forecast service 4 provides the air-conditioning planning device 1 with the forecast information of the outside temperature.

The air-conditioning controller 3 is connected to the air-conditioning units 10 to 12, the hygro-thermometer 20, and the thermometers 21 and 22 and can exchange information among them in accordance with predetermined procedures. Between those devices, routers, hubs and the like, which are not shown in the figure, are installed.

The air conditioning units 10 to 12 in this embodiment are installed in one room. If this embodiment is applied to the air-conditioning of two or more rooms, the air-conditioning planning device 1 creates an air-conditioning plan for each room.

The air-conditioning planning device 1 collects various types of information such as the weather forecast obtained from the weather forecast service 4, the information of power usage of the OA equipment, air-conditioning units 10 to 12, and the ventilation unit 8 (the information of power usage is obtained from the wattmeter 7 via the air-conditioning controller 3), the room temperature and the room humidity obtained from the hygro-thermometer 20, the outside temperature obtained from the thermometer 21, and the frame temperature obtained from the thermometer 22.

The air-conditioning planning device 1 creates an air-conditioning control plan in advance using the collected information and sends the plan to the air-conditioning controller 3. The air-conditioning controller 3 controls the air conditioning units 10 to 12 and the ventilation unit 8 based on the received air-conditioning control plan. The air conditioning units 10 to 12 and the ventilation unit 8 controlled by the air-conditioning controller 3 are collectively described as the HVAC unit.

FIG. 2 is a block diagram showing the physical configuration of the air-conditioning planning device 1 of Embodiment 1.

The air-conditioning planning device 1 is a computer having a processor 41, a memory 42, a communication interface 43, and an auxiliary storage device 44, for example. The air-conditioning planning device 1 may have an interface connected to an input device and an output device as necessary.

The function of the air-conditioning planning device 1 is achieved by the processor 41 executing programs stored in the memory 42.

The memory 42 includes a ROM that is a non-volatile storage element and includes a RAM that is a volatile storage element. The ROM stores therein invariable programs (, such as BIOS). The RAM is a high-speed volatile storage element, such as a DRAM, and temporarily stores programs stored in the auxiliary storage device and data used for running the programs.

Specifically, the memory 42 stores therein an air-conditioning planner 45 as a program. The memory 42 has various types of data, such as time data 46, weather forecast data 47, building forecast data 48, and an air-conditioning control plan option 49. The time data 46, weather forecast data 47, building forecast data 48, and the air-conditioning control plan option 49 are data generated as a result of the processing of the air-conditioning planner 45.

The auxiliary storage device 44 is a large-capacity non-volatile storage device, such as a magnetic storage device (HDD) and a flash memory (SSD), and may be installed inside or outside of the air-conditioning planning device 1. The auxiliary storage device 44 stores therein programs to be run by the processor 41 and stores data used for running the programs. That is, the programs are read out from the auxiliary storage device 44, loaded to the memory 42, and run by the processor 41.

The communication interface 43 is a network interface device that controls communications between the air-conditioning planning device 1 and other devices such as the air-conditioning controller 3, the weather forecast service 4, and the PC 9 in accordance with a predetermined protocol.

The communication interface 43 may also be connected to the input device and the output device in addition to the PC 9. The communication interface 43 can receive instructions from a user input through the PC 9 or the input device. The communication interface 43 may also be configured to transmit data to the PC 9 or the output device for displaying the processing results generated by the air-conditioning planning device 1.

The programs run by the processor 41 are provided to the air-conditioning planning device 1 through a removable medium (CD-ROM, flash memory, and the like) or a network, and are stored in the auxiliary storage device 44, which is a non-temporary storage medium. Thus, it is preferable that the air-conditioning planning device 1 have an interface to read the data from the removable medium.

The air-conditioning planning device 1 is a computer system physically constructed on one computing device, or physically or logically constructed on a plurality of computing devices. The programs described above may be operated on separate threads on the same computing device, or may be operated on a virtual computer constructed on a plurality of physical computer resources.

In the descriptions below, the functions of the air-conditioning planner 45 are achieved by programs, but the air-conditioning planner 45 may be achieved by an integrated circuit, such as LSI.

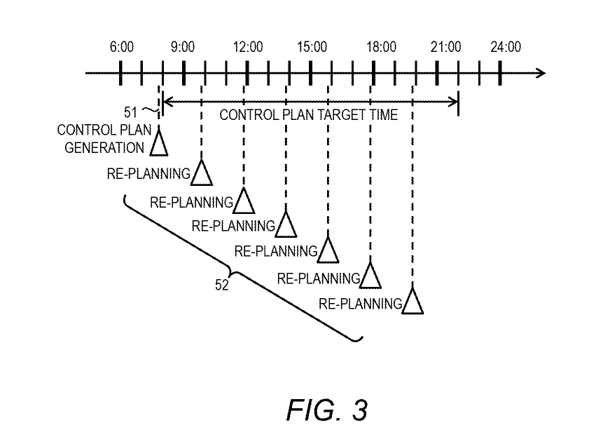

FIG. 3 is an explanatory diagram showing a schedule on which the air-conditioning planning device 1 of Embodiment 1 conducts processing.

Immediately before starting the operation of the HVAC unit, the air-conditioning planning device 1 generates the first air-conditioning control plan. For example, around 7:50 am, the air-conditioning planning device 1 generates an air-conditioning control plan that covers 8 am to 0 am of the day, and sends the generated plan to the air-conditioning controller 3 (control plan generation 51).

“Immediately before starting the operation of the HVAC unit” means a timing that gives enough time for the air-conditioning planning device 1 to accurately predict the room temperature and power usage, and the timing allows for a sufficient processing time of the air-conditioning planning device 1 and a sufficient communication time between the air-conditioning planning device 1 and the air-conditioning controller 3.

If the actual weather is different from the weather forecast, the actual result does not necessarily match the plan, and therefore, the air-conditioning planning device 1 generates a new plan every two hours after that (re-planning 52).

The timings of the control plan generation 51 and re-planning 52 shown in FIG. 3 are examples, and there are not special limitations on those timings. The air-conditioning planning device 1 of this embodiment may generate a control plan only once.

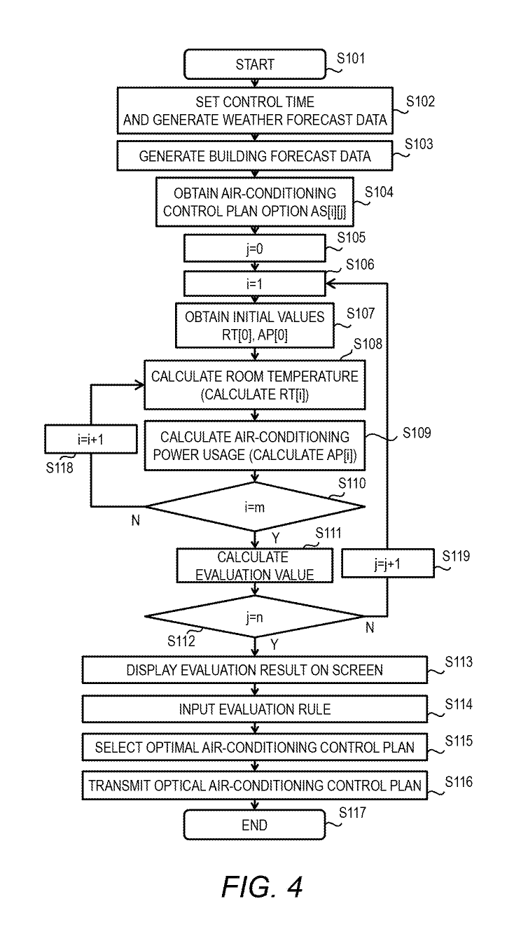

FIG. 4 is a flow chart showing the air-conditioning control plan generation processing conducted by the air-conditioning planning device 1 of Embodiment 1.

The air-conditioning planner 45 starts the processing shown in FIG. 4 at the timing of the generation of control plan 51 and re-planning 52 (S101). In this embodiment, a day on which the processing of FIG. 4 is conducted is described as a control day.

First, the air-conditioning planner 45 obtains weather forecast information (, such as hourly temperature forecast and hourly sunlight level forecast) for the area that includes the building 30 from the weather forecast service 4. The air-conditioning planner 45 sets the time data 46 including time T[i] and converts the obtained forecast information to the outside temperature OT[i](° C.) and the sunlight level SR[i] (W/m²) at the time T[i].

This way, the air-conditioning planner 45 generates the weather forecast data 47 including the outside temperature OT[i] and the sunlight level SR[i] at the time T[i] (S102). The time T[i] is a time at which the air-conditioning controller 3 changes the setting values of the HVAC unit (control time). The number “i” is an integer from 0 to m inclusive.

The air-conditioning planning device 1 obtains physical amounts related to air-conditioning (, such as outside temperature, sunlight level, room temperature, humidity, and air-conditioning power usage) from the thermometer 21, the hygro-thermometer 20, and the like required for the air-conditioning control by the air-conditioning controller 3. The air-conditioning planning device 1 obtains the physical amounts related to air-conditioning at the time T[i] as well.

The air-conditioning planning device 1 generates an air-conditioning control plan including the setting values at the time T[i] such that the HVAC unit changes the setting values for air-conditioning at the time T[i].

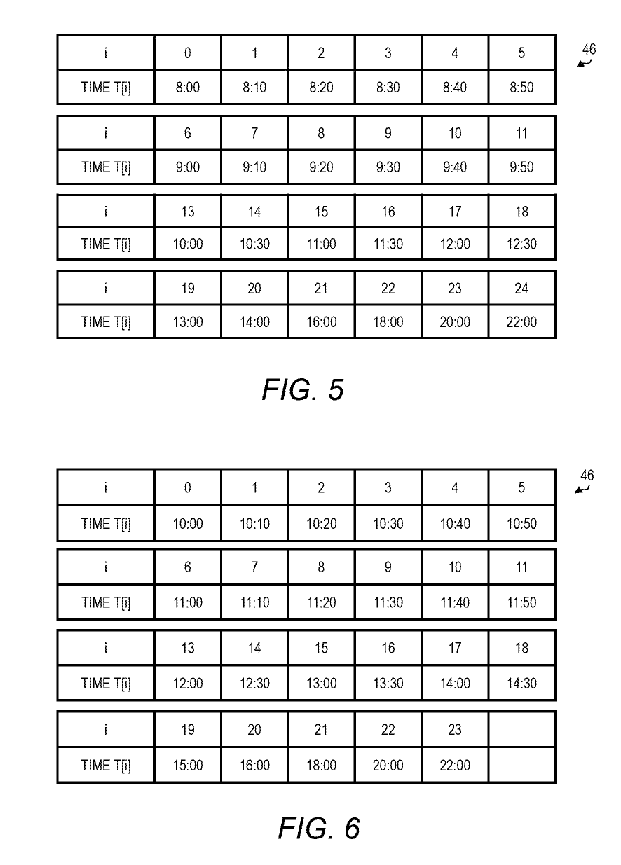

FIG. 5 is an explanatory diagram showing an example of the time data 46 generated in the generation of control plan 51 of Embodiment 1.

FIG. 6 is an explanatory diagram showing an example of the time data 46 generated in the re-planning 52 of Embodiment 1.

FIGS. 5 and 6 indicate the time data 46 including the time T[i] in Embodiment 1. The time T represents a plurality of times during the operation period of the HVAC unit.

The interval between the time T[i] and the time T[i+1] may be even. On the other hand, the longer it has been from the generation of a plan, the more difficult it is for the air-conditioning planner 45 to make an accurate forecast because of uncertain factors such as weather change, and therefore, it is possible to configure the air-conditioning planner 45 of this embodiment to reduce the calculation amount as time proceeds by using a method to define the time T[i] such that the time interval between the time T[i] and the time T[i+1] increases as the time T[i] and the time T[i+1] go further away from the time T[0].

In Step S102, the air-conditioning planner 45 sets the time T[i] by a predetermined method such as setting the interval of the time T[i] to 10 minutes for the first two hours after the plan was generated, and extending the interval to 30 minutes between two hours and five hours after the plan was generated. The time T[i] is then stored in the memory 42 as the time data 46.

The time T when the air-conditioning planner 45 generates a plan immediately before Sam is shown in FIG. 5. In FIG. 5, the air-conditioning planner 45 sets the interval of the time T to 10 minutes from Sam to 10 am, 30 minutes from 10 am to 1 pm, one hour from 1 pm to 4 pm, and two hours from 2 pm to 10 pm.

The time T when the air-conditioning planner 45 conducts re-planning 52 at 9:50 am (immediately before 10 am) is shown in FIG. 6. In FIG. 6, the air-conditioning planner 45 sets the interval of the time T to 10 minutes from 10 am to 12 pm, 30 minutes from 12 pm to 2 pm, one hour from 2 pm to 4 pm, and two hours from 4 pm to 10 pm.

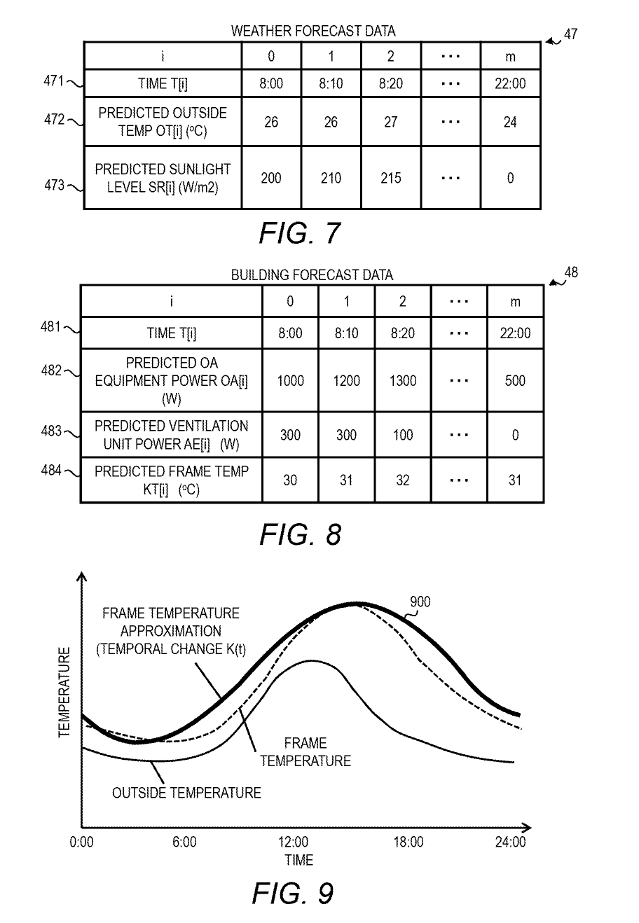

FIG. 7 is an explanatory diagram showing the weather forecast data 47 of Embodiment 1.

The weather forecast data 47 of FIG. 7 includes outside temperature OT[i] 472 and sunlight level SR[i] 473 at the time T[i] predicted by the air-conditioning planner 45. The time T[i] 471 corresponds to each timing in the time data 46.

The outside temperature OT[i] 472 and the sunlight level SR[i] 473 indicate the outside temperature OT[i] and the sunlight level SR[i] predicted in Step S102.

The weather forecast data 47 may also include the cloud cover forecast and the like in addition to the items shown in FIG. 7.

The air-conditioning planner 45 finds the outside temperature OT[i] and the sunlight level SR[i] at each time T based on the forecast information obtained from the weather forecast service 4. For example, the air-conditioning planner 45 finds the outside temperature OT[i] and the sunlight level SR[i] by assuming that the actual temperature and sunlight level change in a linear manner as time proceeds.

Specifically, when the air-conditioning planner 45 is to find the outside temperature OT[1] at the time T[1] of FIG. 5 (=8:10) on condition that the obtained forecast information includes hourly temperature forecast and sunlight level forecast such as at Sam and 9 am, the air-conditioning planner subtracts the predicted temperature at Sam from the predicted temperature at 9 am, divides the result by 6, and adds the division result to the predicted temperature at 8 am. The resultant value is the outside temperature OT[1].

The air-conditioning planner 45 may use any method as long as the outside temperature OT[i] and the sunlight level SR[i] can be found based on the obtained forecast information. In Step S102, the air-conditioning planner 45 stores, in the memory 42, the obtained outside temperature OT[i] and sunlight level SR[i] as the weather forecast data 47.

After Step S102, the air-conditioning planner 45 generates the building forecast data 48 at a time T[i] that is array data including OA equipment power usage OA[i] (W) of the OA equipment, ventilation power usage AE[i] (W) of the ventilation unit 8, and frame temperature KT[i] (° C.) (S103). An example of the generated building forecast data 48 is shown in FIG. 8.

FIG. 8 is an explanatory diagram showing the building forecast data 48 of Embodiment 1.

The building forecast data 48 includes time T 481, OA equipment power usage forecast 482, ventilation unit power usage forecast 483, and frame temperature forecast 484. The time T 481 corresponds to each timing in the time data 46.

The OA equipment power usage forecast 482 stores therein the OA equipment power usage OA[i], and indicates the forecasted amount of power consumed by the OA equipment installed in the building 30. The ventilation unit power usage forecast 483 stores therein the ventilation power usage AE[i], and indicates an estimated amount of power consumed by the ventilation unit 8. The frame temperature forecast 484 stores therein the frame temperature KT[i], and indicates an estimated value of the frame temperature.

The power usage of the OA equipment varies depending on, for example, the number of people in the building 30, the day of the week, and events scheduled on that day. Thus, the air-conditioning planner 45 may be configured to obtain a schedule of workers, calendar information, and the like, and to select or add a predetermined coefficient in accordance with the situation indicated by the obtained information.

If the schedule of workers and the calendar information are not on an hourly basis, but for a whole day, the air-conditioning planner 45 may calculate the same value for the OA equipment power usage OA[i] at each time. If the schedule of workers and the calendar information are on an hourly basis, the air-conditioning planner 45 may obtain the OA equipment power usage OA[i] per hour, and then obtain the OA equipment power usage OA[i] per minute, assuming that the value changes within an hour have a linearity.

If storing information on situations and power usages in the past, the air-conditioning planner 45 may be configured to identify the power usage for a past situation similar to the situation indicated by the obtained information, and obtain the average of the past usage as the power usage forecast.

The circumstance information such as the schedule of workers and calendar information may be entered into the air-conditioning planning device 1 by an operator through the PC 9 before the start of the processing of FIG. 4.

The ventilation unit 8 operates in accordance with an operation schedule specified by a calendar. The air-conditioning planner 45 obtains the ventilation power usage AE[i] of the ventilation unit 8 based on the operation schedule and the past results. The air-conditioning planner 45 may obtain the ventilation power usage AE[i] based on the operation plan generated on the day before the control day, on which the air-conditioning control plan was generated.

The information such as the operation plan and past results may be entered into the air-conditioning planning device 1 by an operator through the PC 9 before the start of the processing of FIG. 4.

FIG. 9 is an explanatory diagram showing the outside temperature, actual frame temperature, and approximate frame temperature of Embodiment 1.

The frame temperature is a temperature of the frame, such as wall surfaces and floor surfaces of the building. The frame temperature reaches its peak several hours after the peak time of the outside temperature as shown in the temporal change 900 of FIG. 9. It is generally known that the frame temperature transitions along a sine curve of a 24-hour cycle as shown in the temporal change 900.

The frame temperature is affected by not only the outside temperature but also sunlight, the thermal load of the building 30, and the like. Thus, it is difficult to predict the frame temperature.

However, the highest frame temperature and the lowest frame temperature are highly correlated to the sunlight level, outside temperature, room temperature, and the like of the control day and the day before. Thus, the air-conditioning planner 45 calculates the highest frame temperature and the lowest frame temperature based on the actual values of sunlight level and the like up to the day before the control day, and the predicted values of sunlight level and the like of the control day.

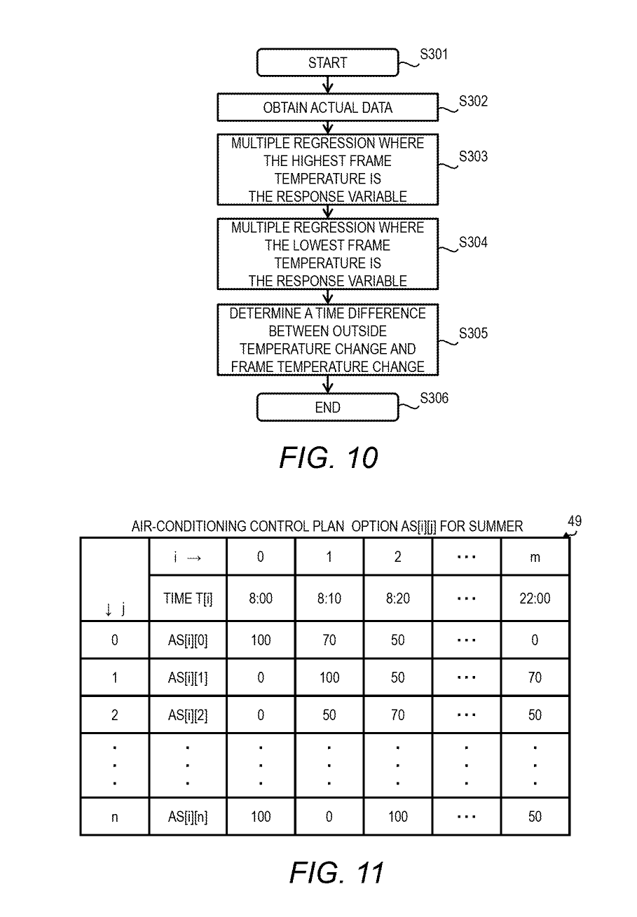

FIG. 10 is a flowchart showing the processing to calculate the frame temperature in Embodiment 1.

The air-conditioning planner 45 may start the processing of FIG. 10 (S301) to generate a formula to calculate the frame temperature before starting the processing of FIG. 4 or periodically. The air-conditioning planner 45 may conduct the processing of FIG. 10 at a certain frequency, such as once a month.

First, the air-conditioning planner 45 retrieves actual data of a past period including the measurement results of any day in the past (past day in the description of FIG. 10) and the day before the past day (S302). The air-conditioning planner 45 may retrieve the actual data of a plurality of days within a predetermined past period.

The actual data of a past period includes the highest frame temperature and the lowest frame temperature of the day before the past day, and the transition data of the sunlight level, outside temperature, and room temperature of the past day and the day before (already measured). The air-conditioning planner 45 also retrieves the air-conditioning control plan used on the day before the past day, as the actual data.

The air-conditioning planner 45 may retrieve the actual data of a past period from any device or interface. For example, if the actual data of a past period is stored in the auxiliary storage device 44 or an external storage device, the air-conditioning planner 45 may retrieve the actual data of a past period from the auxiliary storage device 44 or the external storage device in Step S302. The air-conditioning planner 45 retrieve the actual data of a past period from the air-conditioning controller 3, the PC 9, or the like.

The items of the actual data in the processing of FIG. 10 may include any of the items in the weather forecast data 47 and the items in the building forecast data (except for the frame temperature KT).

The past day may be any time period prior to the start of the processing of FIG. 4 on the control day, and the air-conditioning planner 45 may obtain the result measured before the start of the processing shown in FIG. 4 as the actual data. It is preferable that the past day have the same weather conditions and environment conditions as those of the control day, and therefore, the past day may be the same day at the previous year.

After Step S302, the air-conditioning planner 45 conducts multiple regression calculation where the highest value of the frame temperature of a day before the past day is the response variable and the other items of the actual data (, such as the sunlight level, outside temperature, and room temperature on the past day and on the day before the past day) are explanatory variables. This way, the calculation parameter of the function (highest frame temperature function) to find the highest value of the frame temperature is determined (S303).

After Step S303, the air-conditioning planner 45 conducts multiple regression calculation where the lowest value of the frame temperature of the day before the past day is the response variable and the other items of the actual data (, such as the sunlight level, outside temperature, and room temperature on the past day and on the day before the past day) are explanatory variables. This way, the calculation parameter of the function (lowest frame temperature function) to find the lowest value of the frame temperature is determined (S304).

After Step S304, the air-conditioning planner 45 determines a time difference between the temporal change of the frame temperature on the past day and the temporal change of the outside temperature on the past day (S305). In this processing, the air-conditioning planner 45 may obtain, as the time difference, a difference between the time at which the outside temperature reached the highest level on the past day and the time at which the frame temperature reached the highest level on the past day.

The air-conditioning planner 45 may obtain the average of the time differences throughout the day as the time difference between the temporal change of the outside temperature and the temporal change of the frame temperature. After Step S305, the air-conditioning planner 45 ends the processing of FIG. 10 (S306).

Thereafter, in Step S103 of FIG. 4, the air-conditioning planner 45 predicts the frame temperature at each time T[i] using the calculation parameter (highest frame temperature function) defined in Step S302 of FIG. 10 and the calculation parameter (lowest frame temperature function) defined in Step S303 of FIG. 10, and the weather forecast data 47.

Specifically, the air-conditioning planner 45 calculates the highest frame temperature on the control day based on the calculation parameter defined in Step S302 of FIG. 10 and the function using the actual data of the control day and the day before the control day. The air-conditioning planner 45 also calculates the lowest frame temperature on the control day based on the calculation parameter defined in Step S303 of FIG. 10 and the function using the weather forecast data 47 and the actual data of the control day and a day before the control day.

The air-conditioning planner 45 then generates the frame temperature function for predicting a change in frame temperature on the control day by approximating a temperature change between the time of calculated lowest temperature and the time of highest temperature with a sine curve and the time difference determined in Step S305. Thereafter, in Step S103, the air-conditioning planner 45 calculates the frame temperature at each time T[i] using the frame temperature function, thereby generating array data of the frame temperature KT[i] (frame temperature forecast 484).

The frame temperature function generated in this processing is a function similar to the temporal change 900 shown in FIG. 9 where the value thereof changes along the sine curve of a 24-hour cycle, and the peak value comes later than the peak value of the outside temperature by a predetermined time difference. By approximating the frame temperature function by a sine curve, the frame temperature function can be generated with ease.

Also, by generating the frame temperature function using the highest frame temperature function and the lowest frame temperature function, which are generated based on the actual data, it is possible to predict the frame temperature without manually entering the frame temperature information.

The air-conditioning planner 45 stores, in the memory 42, the OA equipment power usage OA[i], the ventilation power usage AE[i], and the frame temperature KT[i] at the time T[i] which are obtained in Step S103 as the building forecast data 48.

By conducting the processing shown in FIG. 10 to predict the frame temperature in Step S103, the air-conditioning planner 45 can accurately predict the frame temperature based on the actual data. The environment of the space in the building 30 changes in accordance with a change in frame temperature, and therefore, by accurately predicting the frame temperature and using this frame temperature to predict the room temperature and the air-conditioning power usage, it is possible to accurately calculate room temperatures and air-conditioning power usages. As a result, appropriate air-conditioning control plans can be generated.

After Step S103, the air-conditioning planner 45 obtains and stores air-conditioning control plan options AS[i][j] (air-conditioning control plan option 49) in the memory 42 (S104). The number “j” is an integer from 0 to n.

FIG. 11 is an explanatory diagram showing the air-conditioning control plan option 49 for summer of Embodiment 1.

The air-conditioning control plan options AS[i][j] include n+1 number of air-conditioning control plan options AS[i] and take a form of a two-dimensional array of respective times and corresponding plan options. The air-conditioning control plan option AS[i] (each row in the air-conditioning control plan option 49) indicates setting values for the HVAC unit at each time T[i] from the time T[0] to the time T[m].

The number “j” is an argument used to identify a plurality of air-conditioning control plans AS[i] having different combinations of the setting values for air-conditioning control.

The air-conditioning control settings may include at least one of ON/OFF setting of the air-conditioning units, output set-point (%) of the outdoor units, temperature set-point (° C.), a ratio of air-conditioning units that are to be turned on to the total number of air-conditioning units, and an array of the settings for each air-conditioning unit, for example. The air-conditioning control settings may be a combination of a plurality of setting items described in the example above.

The settings of the air-conditioning unit may be a cooling/heating operation mode, the ON/OFF setting of the ventilation unit 8, the power consumption of the ventilation unit 8, the operation intensity of the ventilation unit 8, and the ON/OFF setting of a total heat exchanger.

FIG. 11 shows an example of the air-conditioning control plan option 49 when the air-conditioning control setting has one item. If the air-conditioning control plan option 49 includes a plurality of air-conditioning control setting items, the number of dimensions in the array of the air-conditioning control plan increases in accordance with the number of the air-conditioning control setting items.

Specifically, when the air-conditioning control setting has one item, the air-conditioning control plan option 49 is two-dimensional data (including the variables of time T[i]) shown in FIG. 11. If the air-conditioning control setting has two items, the air-conditioning control plan option 49 is three-dimensional data. If the air-conditioning control setting has three items, the air-conditioning control plan option 49 is four-dimensional data.

In Step S104, the air-conditioning planner 45 may obtain the air-conditioning control plan options AS[i][j] which are set by an operator in advance and store the air-conditioning control plan options AS[i][j] as the air-conditioning control plan option 49. The air-conditioning planner 45 may generate the air-conditioning control plan option 49 by randomly assigning values to the air-conditioning control setting items, and store the data in the memory 42. The air-conditioning planner 45 may generate the air-conditioning control plan option 49 using programs that follow the predetermined rules and may store the data in the memory 42.

The air-conditioning control plan option 49 shown in FIG. 11 is a setting example of the air-conditioning control plan option AS[i][j] for summer. The air-conditioning control setting in the air-conditioning control plan option 49 of FIG. 11 is the output set-point (%) of the outdoor unit of the air conditioning units. The output set-point of the outdoor unit shown in FIG. 11 indicates a positive value, when the air-conditioning unit functions as a cooler, and is a negative value when the air-conditioning unit functions as a heater.

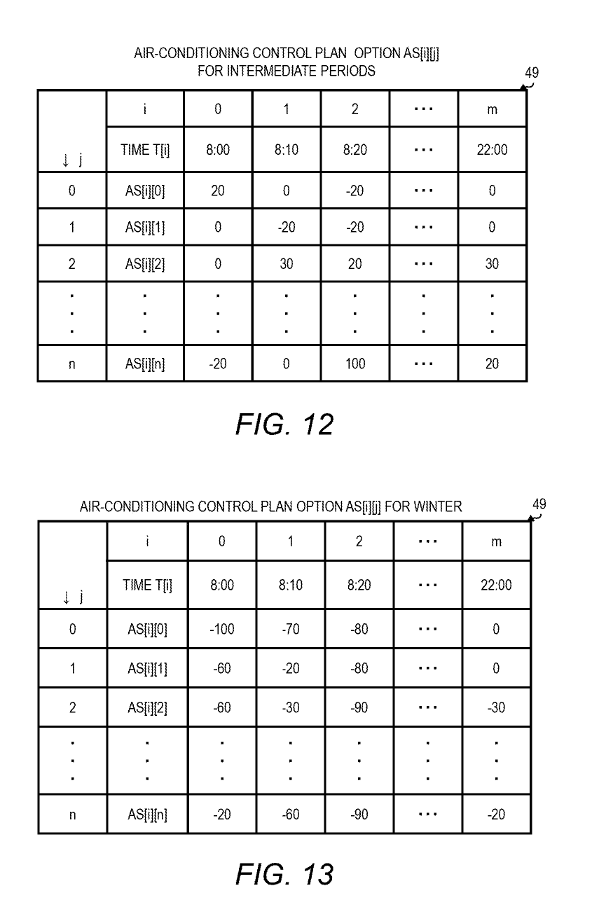

FIG. 12 is an explanatory diagram showing the air-conditioning control plan option 49 for intermediate periods (spring and autumn) of Embodiment 1.

The air-conditioning control setting in the air-conditioning control plan option 49 of FIG. 12 is the output set-point (%) of the outdoor unit of the air-conditioning unit as in FIG. 11. During the intermediate period, a difference between the highest temperature of a day and the lowest temperature of the day is great, and therefore, the air-conditioning unit might switch between the cooling function and the heating function throughout one day. In order to illustrate the switching, the values of the air-conditioning control plan option 49 of FIG. 12 include both positive and negative values.

FIG. 13 is an explanatory diagram showing the air-conditioning control plan option 49 for winter in Embodiment 1.

The air-conditioning control setting in the air-conditioning control plan option 49 of FIG. 13 is the output set-point (%) of the outdoor unit of the air-conditioning unit as in FIG. 11. The values of the air-conditioning control plan option 49 of FIG. 13 are negative values, which means that the outdoor unit functions as a heater.

After Step S104, the air-conditioning planner 45 stores 0 in the argument “j,” thereby initializing the argument “j” (S105). After Step S105, the air-conditioning planner 45 stores 1 in the argument “i,” thereby initializing the argument “i” (S106).

After Step S106, the air-conditioning planner 45 obtains the room temperature RT[0] and the air-conditioning power usage AP[0] at i=0 (S107). The time T[0] is a timing immediately before the HVCA unit starts operating, and at this time, the space in the building 30 is not affected by the air-conditioning control by the air-conditioning controller. Thus, the air-conditioning power usage AP[0] indicates the air-conditioning power consumed by the HVAC unit when the air-conditioning controller 3 is not controlling the HVAC unit.

The air-conditioning planner 45 of Embodiment 1 obtains the actual measurement of the room temperature from the hygro-thermometer 20 as the room temperature RT[0]. The air-conditioning planner 45 obtains the air-conditioning power usage measured by the wattmeter 7 as the air-conditioning power usage AP[0] when conducting the processing of FIG. 4 (at 7:50 shown in FIG. 3). Below, the room temperature RT[i] and the air-conditioning power usage AP[i] may simply be described as RT[i] and AP[i], respectively.

The time T[0] indicates 8:00 in the time data 46 shown in FIG. 5. However, the air-conditioning planner 45 does not necessarily need to obtain RT[0] and AP[0] exactly at 8:00. Specifically, RT[0] and AP[0] may be obtained at any time as long as it is close enough to the time T[0] and before the setting values for the HVAC unit are changed at the time T[0].

After Step S107, the air-conditioning planner 45 calculates RT[1] using RT[0], AP[0] and the room temperature calculation procedure 55 (air-conditioning calculation function of this embodiment) (S108). The air-conditioning planner 45 then calculates the air-conditioning power usage AP[1] using RT[0], AP[0] and the air-conditioning power usage calculation procedure 56 (air-conditioning power usage calculation function of this embodiment) (S109).

In Steps S108 and S109, the air-conditioning planner 45 stores, in the memory 42, the calculated RT[i] and AP[i] for each air-conditioning control plan option.

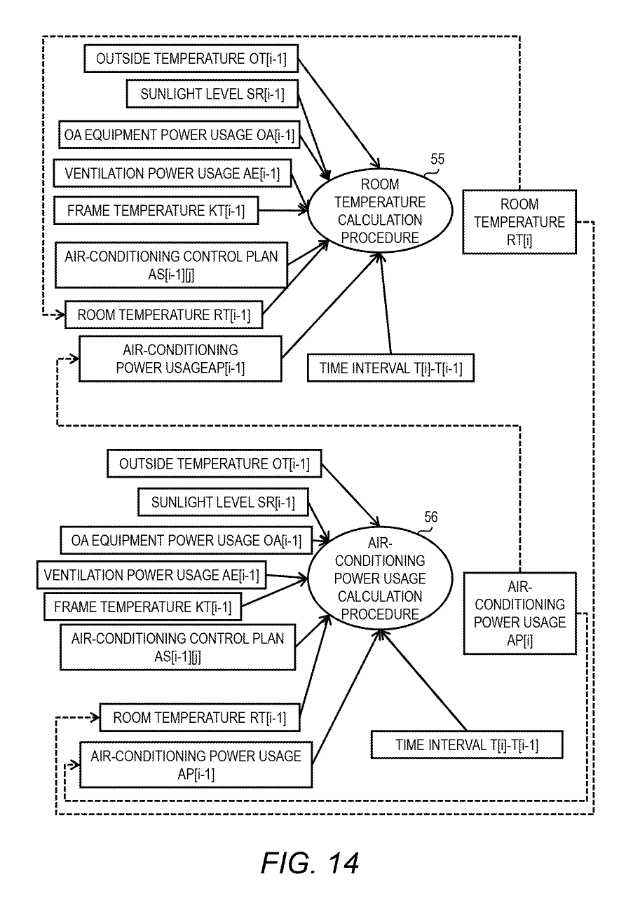

The input and output relationships of the room temperature calculation procedure 55 and the air-conditioning power usage calculation procedure 56 in Steps S108 and S109 are shown in FIG. 14.

FIG. 14 is an explanatory diagram showing the procedures to calculate the room temperature RT[i] and the air-conditioning power usage AP[i] of Embodiment 1.

In Step S108, the air-conditioning planner 45 inputs the outside temperature OT[0], the sunlight level SR[0], the OA equipment power usage OA[0], the ventilation power usage AE[0], the frame temperature KT[0], the air-conditioning control plan AS[0,0], the room temperature RT[0], and the air-conditioning power usage AP[0] into the room temperature calculation procedure 55. The air-conditioning planner 45 obtains the room temperature RT[1] as the output value of the room temperature calculation procedure 55.

In Step S108, the air-conditioning planner 45 obtains the outside temperature OT[0] and the sunlight level SR[0] from the outside temperature forecast 472 and the sunlight level forecast 473 of the weather forecast data 47. The air-conditioning planner 45 obtains the OA equipment power usage OA[0], the ventilation power usage AE[0], and the frame temperature KT[0] from the OA equipment power usage forecast 482, the ventilation unit power usage forecast 483, and the frame temperature forecast 484 of the building forecast data 48. The air-conditioning planner 45 obtains the air-conditioning control plan AS[0,0] from the air-conditioning control plan option 49. In Step S109, the air-conditioning planner 45 inputs the outside temperature OT[0], the sunlight level SR[0], the OA equipment power usage OA[0], the ventilation power usage AE[0], the frame temperature KT[0], the air-conditioning control plan AS[0,0], the room temperature RT[0], and the air-conditioning power usage AP[0] into the air-conditioning power usage calculation procedure 56. The air-conditioning planner 45 obtains the air-conditioning power usage AP[1] as the output value of the air-conditioning power usage calculation procedure 56.

The air-conditioning planner 45 uses the room temperature RT[1] calculated in Step S108 to calculate the room temperature RT[2] and the air-conditioning power usage AP[2] in the subsequent Step S108. Similarly, the air-conditioning planner 45 uses the air-conditioning power usage AP[1] calculated in Step S109 to calculate the room temperature RT[2] and the air-conditioning power usage AP[2] in the subsequent Step S108.

The room temperature calculation procedure 55 and the air-conditioning power usage calculation procedure 56 are represented by the functions using explanatory variables. The simplest calculation procedure is expressed by a linear expression in which calculation parameters such as a gradient is set for each explanatory variable. For example, the room temperature calculation procedure 55 is expressed as Formula 1, and the air-conditioning power usage calculation procedure 56 is expressed as Formula 2.

RT[i]=a0+(a1*OT[i−1]+a2*SR[i−1]+a3*OA[i−1]+a4*AE[i−1]+a5*KT[i−1]+a6*AS[i−][j]+a7*RT[i−1]+a8*AP[i−1])*(T[I]−T[i−1]) (Formula 1)

AP[i]=b0+(b1*OT[i−1]+b2*SR[i−1]+b3*OA[i−1]+b4*AE[i−1]+b5*KT[i−1]+b6*AS[i−1][j]+b7*RT[i−1]+b8*AP[i−1])*(T[i]−T[i−1]) (Formula 2)

a0 to a8 in Formula 1 and b0 to b8 in Formula 2 are calculation parameters set for each explanatory variable. The explanatory variables are the outside temperature OT[i−1], the sunlight level SR[i−1], the OA equipment power usage OA[i−1], the ventilation power usage AE[i−1], the frame temperature KT[i−1], the air-conditioning control plan AS[i−1, j], the room temperature RT[i−1], and the air-conditioning power usage AP[i−1].

As described above, the air-conditioning planner 45 is configured to obtain the room temperature RT[i] and the air-conditioning power usage AP[i] using the function including a plurality of elements as the explanatory variables, and therefore, it is possible to select and apply an appropriate air-conditioning control plan to accommodate more complex changes in environment.

The room temperature calculation procedure 55 and the air-conditioning power usage calculation procedure 56 of this embodiment need to include, as the explanatory variables, the air-conditioning control plan AS, the room temperature RT, and the air-conditioning power usage AP. That is, the room temperature calculation procedure 55 and the air-conditioning power usage calculation procedure 56 may include any elements as long as the following room temperature and air-conditioning power usage are obtained based on the air-conditioning control plan, the room temperature, and the air-conditioning power usage. The air-conditioning planner 45 obtains the values of the calculation parameters ax and bx (x=0 to 8) through multiple regression.

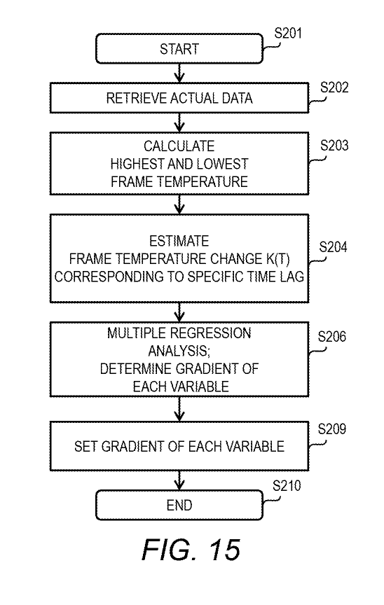

FIG. 15 is a flowchart showing the processing to generate the room temperature calculation procedure 55 and the air-conditioning power usage calculation procedure 56 of Embodiment 1.

The air-conditioning planner 45 starts the processing of FIG. 15 before starting the processing of FIG. 4 or periodically (S201). This way, the air-conditioning planner 45 can calculate the calculation parameters ax and bx, and generate the room temperature calculation procedure 55 (room temperature calculation function) and the air-conditioning power usage calculation procedure 56 (air-conditioning power usage calculation function).

The air-conditioning planner 45 retrieves the actual data including the sunlight level, outside temperature, room temperature, OA equipment power usage, ventilation power usage, and air-conditioning power usage which were measured on one day in the past (past day in the description of FIG. 15) and the day before the past day (S202). The air-conditioning planner 45 also retrieves the air-conditioning control plan used on the day before the past day, as the actual data.

The air-conditioning planner 45 may retrieve the actual data from any device as in the processing of FIG. 10.

The actual data of this embodiment may include the sunlight level, outside temperature, room temperature, OA equipment power usage, ventilation power usage, and air-conditioning power usage measured at a plurality of times (corresponding to time T[i]) during a predetermined past period, and the air-conditioning control plans executed during that period.

By using the actual data indicating the results of the air-conditioning control plan that was executed under the weather and environmental conditions similar to those of the control day, the air-conditioning planner 45 can predict the room temperature and air-conditioning power usage of the control day more effectively. Thus, the actual data may be the result of the air-conditioning control conducted on the same day last year, for example.

The air-conditioning planner 45 obtains the actual data of the elements included in the room temperature calculation function and the air-conditioning power usage calculation function that are used in Step S108 and S109. For example, if the room temperature calculation function and air-conditioning power usage calculation function are defined by only the room temperature, air-conditioning control plan, and air-conditioning power usage, the actual data needs to include at least the room temperature, air-conditioning control plan, and air-conditioning power usage.

After Step S202, the air-conditioning planner 45 obtains the highest frame temperature and the lowest frame temperature in the past based on the actual data (S203). The highest frame temperature and the lowest frame temperature may be obtained by extracting the highest value and the lowest value of the frame temperature included in the actual data of the day before the control day, or by calculating the average (or a statistic value, such as median,) of the highest frame temperatures and the lowest frame temperatures included in the actual data of a predetermined past period.

After Step S203, the air-conditioning planner 45 obtains a difference (time lag) between the time at which the peak value of the outside temperature was measured and the time at which the peak value of the frame temperature was measured. Then, using the calculated highest temperature, the calculated lowest temperature, and the obtained time difference, the air-conditioning planner 45 predicts a temporal change K(t) of the frame temperature in the form of a sine curve (S204).

The air-conditioning planner 45 obtains the time difference based on the actual data of the day before the control day, for example. The air-conditioning planner 45 may obtain the average of the time difference throughout the previous week of the processing of FIG. 15 as the time difference used in Step S204.

After Step S204, the air-conditioning planner 45 performs multiple regression based on the actual data of the outside temperature, the sunlight level, the OA equipment power usage, the ventilation power usage, the air-conditioning control plan, the room temperature RT, and the air-conditioning power usage AP, and the frame temperature based on the temporal change K(t) predicted in Step S204. This way, the air-conditioning planner 45 obtains the calculation parameters ax and bx (x=0 to 8) for the room temperature calculation function and the air-conditioning power usage calculation function (S206).

The explanatory variables in the multiple regression include the outside temperature (t−1), the sunlight level (t−1), the OA equipment power usage (t−1), the ventilation power usage (t−1), the frame temperature (t−1), the air-conditioning control plan (t−1), the room temperature RT (t−1), and the air-conditioning power usage AP (t−1), but the explanatory variables may include any elements as long as the room temperature RT (t−1) and the air-conditioning power usage AP(t−1) are included. The response variable in the multiple regression is one of the room temperature RT(t) and the air-conditioning power usage AP(t).

Here, “t” is a point in time in the past at which the actual data was measured (or at which the actual data was executed if the actual data is an air-conditioning control plan), and “t” is generated in the same manner as the method to generate the time T(i) of the time data 46.

By conducting Step S206, the air-conditioning planner 45 generates the room temperature calculation function and the air-conditioning power usage calculation function for finding optimal room temperature and air-conditioning power usage for the control day based on the actual data in the past.

After Step S206, the air-conditioning planner 45 stores, in the memory 42, the values of the calculation parameters ax and bx (x=0 to 8), which are the results of the multiple regression (S209). This way, the calculation parameters ax and bx (x=0 to 8) for Steps S108 and S109 of FIG. 4 are defined.

The air-conditioning planner 45 conducts the processing shown in FIG. 15 every quarter of a year, but if a higher degree of accuracy is required, the processing may be conducted more frequently. In the example described above, the calculation parameters ax and bx are derived from the actual data of the control day and the day before the control day. The air-conditioning planner 45 may conduct the frame temperature calculation processing shown in FIG. 10 and the generation processing of the room temperature calculation function and the air-conditioning power calculation function shown in FIG. 15 at timings differing from each other.

However, the air-conditioning planner 45 may obtain a plurality of combinations of the calculation parameters ax and bx using the actual data of each day of the week, or may use the statistic values (, such as average value or median value,) of the plurality of combinations of the calculation parameters ax and bx as the calculation parameters ax and bx used in Steps S108 and S109.

After Step S109, the air-conditioning planner 45 determines whether the argument “i” is the maximum value (m) or not (S110), and if not, adds 1 to the argument “i” (S118). The processing then returns to Step S108.

By repeating Steps S108 and S109, the air-conditioning planner 45 can calculate the room temperature RT and the air-conditioning power usage AP in a time series including a plurality of times T[i] when one of the air-conditioning control plan options is executed.

If the argument “i” is the maximum value, the air-conditioning planner 45 calculates an evaluation value (S111). The air-conditioning planner 45 of Embodiment 1 calculates, as the evaluation value, APamt that is the total of the air-conditioning power usage during the controlled period and PMVave that is the average of the absolute value of PMV (predicated mean vote).

PMV is an index that represents the degree of comfort which is specified by ISO 7730. PMV is calculated using six indicators: metabolic rates; clothing levels; air temperature (room temperature in Embodiment 1); radiant temperature; air velocity; and humidity. The lower the absolute value of PMV is, the more comfortable people feel. The higher the absolute value of PMV is, the less comfortable a person feels.

The air-conditioning planner 45 uses fixed values for the metabolic rates and clothing levels in each season. The calculated room temperature RT is used for the radiant temperature. The air-conditioning planner 45 may set the air velocity to zero since the velocity inside of the building 30 is substantially zero because there is no radiant heat source. The air-conditioning planner 45 may use a fixed value that represents the average of the air velocity on site.

The air-conditioning planner 45 uses the room temperature RT calculated in Step S108 for the temperature to calculate PMV. The air-conditioning planner 45 may use a humidity level measured on that day (measured by the hygro-thermometer 20). The air-conditioning planner 45 may calculate a predicted value of humidity based on the weather forecast, air-conditioning power usage history, and the like, and use the predicted value to calculate PMV.

After Step S111, the air-conditioning planner 45 determines whether the argument “j” is the maximum value (n) or not (S112), and if not, adds 1 to the argument “j” (S119). The processing then returns to Step S106.

By repeating Step S106 to S111, the air-conditioning planner 45 can find an evaluation value representing the comfort level (PMV: evaluation indicator of this embodiment) and the air-conditioning power usage for each of the air-conditioning control plan options in the air-conditioning control plan option 49 and each of the time T[i].

If the argument “j” is greater than or equal to the maximum value in Step S112, the air-conditioning planner 45 outputs data for displaying the evaluation value for each air-conditioning control plan option in the air-conditioning control plan option 49 (j=0 to n) on the screen of the PC 9 through the communication interface 43 or the input/output interface (S113). The PC 9 or an output device connected to the air-conditioning planning device 1 displays a screen 60 in accordance with the data output from the air-conditioning planning device 1.

Because a plurality of comfort indicators were calculated for the respective times T[i] in Step S111, the air-conditioning planner 45 calculates a statistic value (, such as sum, average, or median,) of the calculated plurality of comfort indicators. This way, the air-conditioning planner 45 calculates a daily statistic value of the comfort indicators for each of the air-conditioning control plan options.

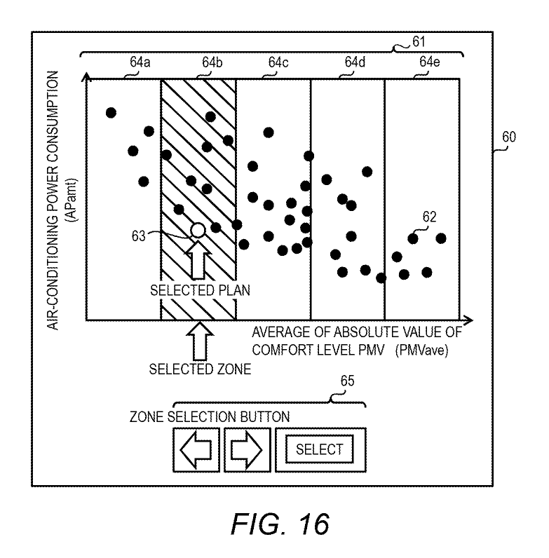

FIG. 16 is an explanatory diagram showing an example of the screen 60 of Embodiment 1.

The screen 60 includes an area 61 and an area 65. The area 61 displays evaluation indicators for the respective air-conditioning control plan options. The area 65 is an area to select a zone that includes the evaluation indicators displayed in the area 61.

In Step S113, the air-conditioning planner 45 calculates the statistic value of the plurality of comfort indicators for each of the air-conditioning control plan options in order to display the screen 60 of FIG. 16. Specifically, the air-conditioning planner 45 calculates the average of the absolute values of PMV (PMVave) as the statistic value.

The air-conditioning planner 45 also calculates the sum of air-conditioning power usage calculated in Step S109 for each of the air-conditioning control plan options. APamt is the daily total of air-conditioning power usage, i.e., the total air-conditioning power usage of the day. APamt is an indicator for the air-conditioning cost. The evaluation indicator of this embodiment is a combination of PMVave and APamt.

The horizontal axis of the area 61 is PMVave, and the vertical axis of the area 61 is APamt. In Step S113, the air-conditioning planner 45 plots a point 62 corresponding to the calculated PMVave and APamt for each of the air-conditioning control plan options AS[i][j] 0=0 to m−1) on the two-dimensional coordinates of the area 61.

The air-conditioning planner 45 of Embodiment 1 also divides the horizontal axis (PMVave) of the area 61 into five zones 64 (64a to 64e) in Step S113 in order to divide the evaluation values of comfort level into a plurality of groups.

The air-conditioning planner 45 also displays a user interface, such as buttons, to allow an operator to select a zone 64 and make an input.

In order to select and input the rule to evaluate the optimal air-conditioning control plan into the air-conditioning planning device 1, the operator selects the most desirable zone 64 from the five zones 64 displayed in the area 61, using the area 65 (S114).

Generally, the higher the comfort level is (the lower the PMVave is), the higher the power usage is. The lower the comfort level is (the higher the PMVave is), the lower the power usage is. The operator can pick a group of air-conditioning control plan options of a lower comfort level but lower power usage by selecting a zone 64 with a greater PMVave, and can pick a group of air-conditioning control plan options of a higher comfort level but higher power usage by selecting a zone 64 with a smaller PMVave.

The operator selects a zone 64 taking into consideration the air-conditioning control cost and the like of the building 30. The operator selects a zone 64 using the arrow button in the area 65, for example, and inputs the selected zone 64 using the select button. In the area 61 of FIG. 16, the operator selects the zone 64b.

PC 9 receives the zone 64b as an input from the operator. PC 9 then sends, to the air-conditioning planning device 1 through the gateway 31, the information indicating the selected zone 64b. The air-conditioning planner 45 of the air-conditioning planning device 1 obtains the information that indicates the zone 64b being the evaluation rule.

By outputting data for displaying the screen 60 and obtaining the evaluation rule, the air-conditioning planner 45 can provide the user with information to make a decision on an air-conditioning control plan, and can appropriately set the air-conditioning control plan in accordance with a decision of the user.

The air-conditioning planner 45 has a preset evaluation rule to select an air-conditioning control plan option with the lowest air-conditioning power usage APamt as an air-conditioning control plan to be applied. Thus, after Step S114, the air-conditioning planner 45 selects an air-conditioning control plan option that matches the evaluation rule input by the operator (zone 64b) and the preset evaluation rule, as the air-conditioning control plan to be applied (S115).

Specifically, the air-conditioning planner 45 selects, from the air-conditioning control plan options in the zone 64b, an air-conditioning control plan option with the lowest air-conditioning power usage APamt.

This way, the air-conditioning planner 45 can select an air-conditioning control plan to be applied to the air-conditioning controller 3 from the air-conditioning control plan options in accordance with the obtained evaluation rule. The selected air-conditioning control plan is stored in the memory 42, and then displayed in the screen 60 as the optimal air-conditioning control plan.

The point 63 shown in FIG. 16 indicates the selected optimal air-conditioning control plan. Information included in the optimal air-conditioning control plan corresponds to one row of the air-conditioning control plan option 49 shown in FIG. 12.

The air-conditioning planner 45 obtains the evaluation rule in Step S114 after displaying the evaluation values (PMVave, APamt) in Step S113 described above. However, in the air-conditioning planner 45 of this embodiment, the criteria of the evaluation rule selected by the operator (such as selecting a zone 64 of the lowest PMVave) may be set in advance.

In this case, the air-conditioning planner 45 may select an optimal air-conditioning control plan from the air-conditioning control plan options under the evaluation rule that matches the pre-defined criteria in Step S115 without conducting Step S113 and S114. For example, the operator may set the air-conditioning planner 45 in advance so that a zone 64 of the highest comfort level is selected.

In the example described above, the air-conditioning planner 45 selects an air-conditioning control plan option of the lowest air-conditioning power usage APamt from the air-conditioning control plan options in accordance with the selected evaluation rule. However, the air-conditioning planner 45 may have a standard of the air-conditioning power usage for selecting an air-conditioning control plan option, which is set by an operator in advance.

After Step S115, the air-conditioning planner 45 sends the selected optimal air-conditioning control plan to the air-conditioning controller 3 (S116). The air-conditioning controller 3 controls air-conditioning in the building 30 in accordance with the received optimal air-conditioning control plan.

As described above, in Embodiment 1, it is possible to generate a control plan for the air-conditioning units 10 to 12 that achieves both high level of comfort and low energy consumption. The air-conditioning control plan is selected based on the actual data of a past period, and the room temperature [0] and air-conditioning power usage [0] of the control day, and therefore, the air-conditioning unit can be operated in the most appropriate way automatically without requiring an engineer who has knowledge on architecture and HVAC unit.

In Embodiment 1, the actual data is continuously retrieved and the air-conditioning control plan is set in accordance with the retrieved actual data, and therefore, not only when air-conditioning units are newly installed, but also when the layout or purpose of the building has changed, the most appropriate air-conditioning operation can be automatically achieved without manually changing parameters to accommodate the modification or change in the air-conditioning units.

### Embodiment 2

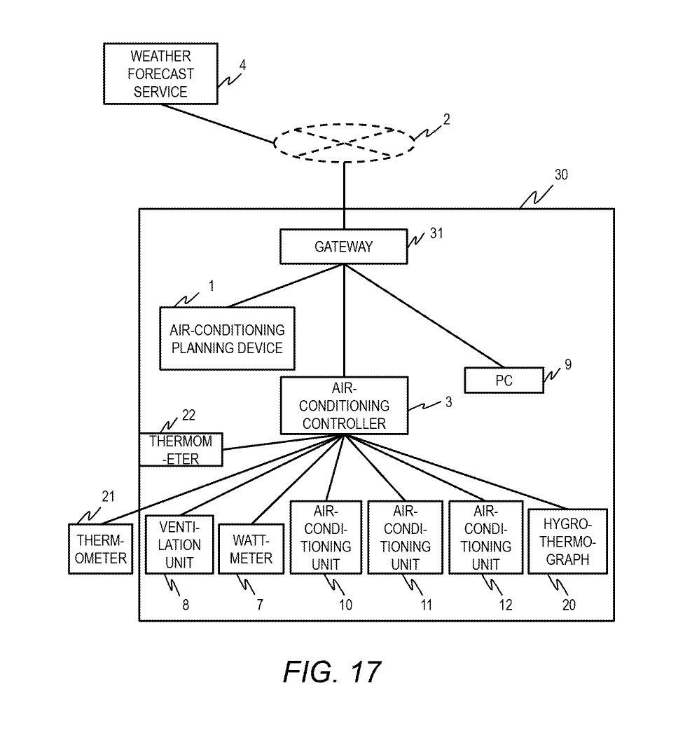

FIG. 17 is a block diagram showing an example of the device configuration and the communication network configuration of Embodiment 2.

The air-conditioning control system, the communication network 2, and the weather forecast service 4 of Embodiment 2 are the same as the air-conditioning control system, the communication network 2, and the weather forecast service 4 of Embodiment 1.

The air-conditioning planning device 1 of Embodiment 2 is installed inside of the building 30 to be controlled, and is connected to the gateway 31. The air-conditioning planning device 1 of Embodiment 2 differs from the air-conditioning planning device 1 of Embodiment 1 in this point.

According to Embodiment 2, because all the functions except for the weather forecast service 4 are installed in the building 30, a closed operation within the building 30 can be achieved. More specifically, the air-conditioning control system of Embodiment 2 is an effective system when the operator of the building 30 wants the air-conditioning control plan and the information to select the optimal air-conditioning control plan (, such as the predicted OA equipment power usage,) to be kept within the building 30. The air-conditioning control system of Embodiment 2 is also effective when the system needs to be operated independently in case of emergency and the like.

The operation schedule of the air-conditioning planning device 1 of Embodiment 2 described below is the same as the operation schedule of Embodiment 1 shown in FIG. 3.

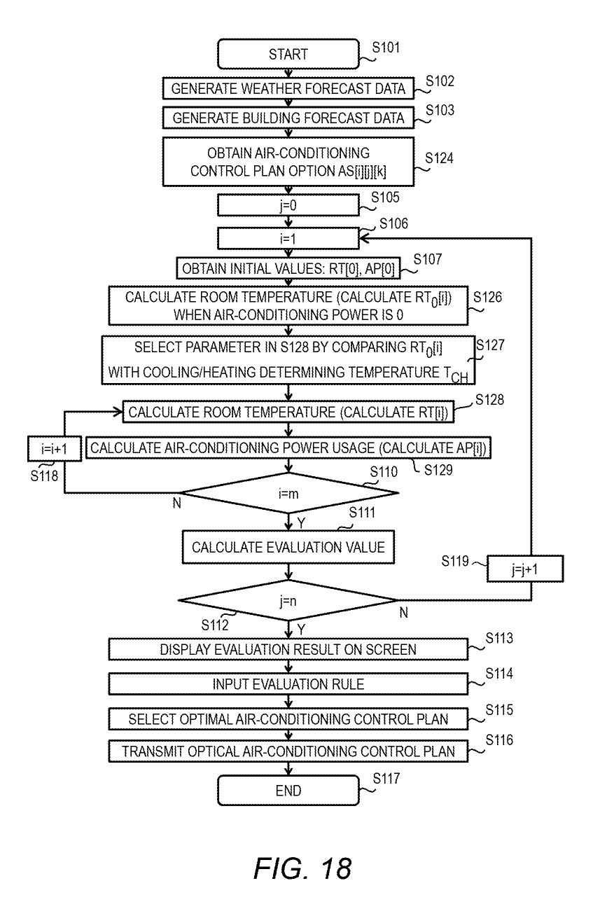

FIG. 18 is a flowchart showing the air-conditioning control plan generation processing by the air-conditioning planning device 1 of Embodiment 2.

Steps S101 to S103, Steps S105 to S107, and Steps S110 to S119 of Embodiment 2 are the same as Steps S101 to S103, Steps S105 to S107, and Steps S110 to S119 of Embodiment 1, respectively.

Step S124 of Embodiment 2 corresponds to Step S104 of Embodiment 1. Steps S128 and S129 of Embodiment 2 correspond to Steps S108 and S109 of Embodiment 1, respectively. A difference between Step S124 and Step S104 and a difference between Steps 128 to S129 and Steps 108 to S109 are described below.

After Step S103, the air-conditioning planner 45 of Embodiment 2 obtains, as the air-conditioning control plan option 49, air-conditioning control plan options AS[i][j][k] (k is an integer of 0 to 1) (S124). Step S124 differs from Step S104 in this point.

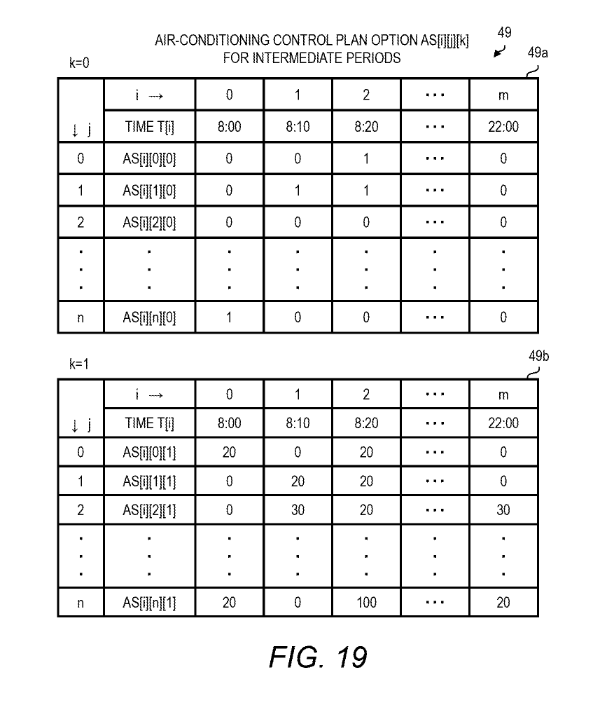

FIG. 19 is an explanatory diagram showing an air-conditioning control plan option 49 for intermediate periods of Embodiment 2.

The air-conditioning control plan option 49 of Embodiment 2 includes an air-conditioning control plan option AS49a and an air-conditioning control plan option AS49b. The air-conditioning control plan option AS49a represents air-conditioning control plan options AS[i][j][0] that are air-conditioning control plan options for cooling. The air-conditioning control plan option AS49b represents air-conditioning control plan options AS[i][j][1] that are air-conditioning control plan options for heating.

The air-conditioning control plan option AS[i][j][k] is the three-dimensional array constituted of two of the array [i][j] that includes n+1 number of air-conditioning control plan options AS[i], each of which is a group of air-conditioning control settings for each time period from the time T[0] to the time T[m].

The column k includes the column 0 that represents heating or cooling by having 0 or 1 and includes the column 1 that indicates the output set-point (%) of the outdoor unit of the air-conditioning unit.

In a manner similar to Step S104, the air-conditioning control plan options AS[i][j][k] that are set by an operator in advance may be obtained and stored in the memory 42 as the air-conditioning control plan option 49 in Step S124.

The air-conditioning planner 45 may generate the air-conditioning control plan option 49 by randomly assigning values to the air-conditioning control setting items, and store the data in the memory 42. The air-conditioning planner 45 may generate the air-conditioning control plan option 49 using programs that follow the predetermined rules, and store the data in the memory 42.

By adding another dimension to differentiate cooling and heating to the array of the air-conditioning control plan option 49 in Step S124, the function settings of cooling and heating can be input with ease. After Step S124, the air-conditioning planner 45 conducts Step S105.

The calculation parameter (a8 in Formula 1) used in Step S128 (Step S108 in FIG. 4) and indicating the effect of the air-conditioning power usage AP on the room temperature RT greatly differs between when cooling is conducted for the air-conditioning control and when heating is conducted for the air-conditioning control. Thus, in the intermediate period when it is necessary to switch between heating and cooling in a short period of time, the calculation parameter for cooling and the calculation parameter for heating need to be selected accurately.

Therefore, in the intermediate period in particular, after Step S107, the air-conditioning planner 45 sets the air-conditioning power usage AP to 0, and predicts the room temperature (RT0[i]) of the control day using calculation parameters (a0 to a7 of Formula 3 below) calculated based on the actual data in the air-conditioning control plan executed on the day before the control day (or a past period having similar conditions to the control day) (S126). The calculation formula in Step S126 is represented as Formula 3, for example.

RT0[i]=a0+(a1*OT[i−1]+a2*SR[i−1]+a3*OA[i−1]+a4*AE[i−1]+a5*KT[i−1]+a6*AS[i−1]+a7*RT[i−1])*(T[i]−T[i−1]) (Formula 3)

OT[i−1], SR[i−1], OA[i−1], AE[i−1], and KT[i−1] in Formula 3 are values of the weather forecast data 47 and the building forecast data 48 of the control day. AS[i−1] in Formula 3 is the air-conditioning control plan applied on the day before the control day. Because Formula 3 is the room temperature calculation function when the air-conditioning power usage is 0, Formula 3 needs to include at least the air-conditioning control plan option AS and the room temperature RT as the elements thereof.

After Step S126, the air-conditioning planner 45 selects the calculation parameter and air-conditioning control plan options for cooling or the calculation parameter and air-conditioning control plan options for heating, depending on whether or not RT₀[i] is smaller than a cooling/heating determining temperature T_{CH}, which is a predetermined target value (S127).

Specifically, when RT₀[i] is smaller than the cooling/heating determining temperature T_{CH}, the air-conditioning planner 45 determines that the calculation parameter and air-conditioning control plan option AS[i][j][1] for heating need to be used in Step S128 and S129. When RT₀[i] is equal to or greater than the cooling/heating determining temperature T_{CH}, the air-conditioning planner 45 determines that the calculation parameter and air-conditioning control plan option AS[i][j][0] for cooling need to be used in Step S128 and S129. The air-conditioning planner 45 stores, in the memory 42, the selected calculation parameter and air-conditioning control plan option AS.

In the processing of FIG. 15, the air-conditioning planner 45 finds the calculation parameter for heating by obtaining, as the actual data (heating actual information) the result of applying the air-conditioning control plan for heating and by performing multiple regression. Also, in the processing of FIG. 15, the air-conditioning planner 45 finds the calculation parameter for cooling by obtaining, as the actual data (cooling actual information), which is the result of applying the air-conditioning control plan for cooling and by performing multiple regression.

The cooling/heating determining temperature T_{CH} may be a fixed value that is input in advance, or may be derived through back calculation using the measured humidity to make PMV zero. In other words, the cooling/heating determining temperature T_{CH} is a room temperature when ideal control is conducted, and Formula 3 is a room temperature when air-conditioning control is not conducted using the air-conditioning power.

The method described above to select the elements for heating or the elements for cooling is an example, and the air-conditioning planner 45 may use any selection method. For example, the air-conditioning planner 45 may calculate two RT₀[i] using the calculation parameter for heating and calculation parameter for cooling which are calculated based on the actual data of the day before the control day or earlier and using Formula 3.

In this case, the air-conditioning planner 45 may select one of the calculation parameter for heating and the calculation parameter for cooling by determining which RT₀[i] is closer to the cooling/heating determining temperature T_{CH} and use the selected calculation parameter in Steps S128 and S129.

Steps S126 and S127 are conducted only when i=1, but it is also possible to conduct Steps S126 and S127 after Step S118 so that air-conditioning control plans for heating and cooling are switched between each other at each control time.

Through Step S127, the air-conditioning planner 45 can select one of the calculation parameter for cooling and the calculation parameter for heating depending on the conditions of the control day and can generate appropriate room temperature calculation function and air-conditioning power calculation function. As a result, an effective air-conditioning control plan can be generated.

By predicting the room temperature of the zero air-conditioning power usage, the temperature of the room without the air-conditioning is predicted. The predicted value is used to differentiate the cooling parameter from heating parameter. As a result, it is possible to identify the cooling parameter and heating parameter appropriately.

After Step S127, the air-conditioning planner 45 of Embodiment 2 calculates the room temperature RT[1] using the same procedures as Steps S108 and S109 of Embodiment 1, and in accordance with the selection made in Step S127 (Step S128), calculates the air-conditioning power usage AP[1] (S129).

When Steps S126 and S127 are not conducted, the air-conditioning planner 45 of Embodiment 2 may calculate the room temperature RT[1] using the air-conditioning control plan option AS[1][j][0], and then calculate the room temperature RT[1] using the air-conditioning control plan option AS[1][j][1].

When using the air-conditioning control plan option AS[1][j][1], the air-conditioning planner 45 multiplies the output set-point of the outdoor unit indicated by the air-conditioning control plan option AS49b by −1, and calculates the room temperature RT[1].

In Step S129, the air-conditioning planner 45 may calculate the air-conditioning power usage AP[1] using the air-conditioning control plan option AS[1][j][0], and then calculate the air-conditioning power usage AP[1] using the air-conditioning control plan option AS[1][j][1]. When using the air-conditioning control plan option AS[1][j][1], the air-conditioning planner 45 multiplies the output set-point of the outdoor unit indicated by the air-conditioning control plan option AS49b by −1, and calculates the air-conditioning power usage AP[1].

After Step S129, the air-conditioning planner 45 conducts Step S110. Steps S110 to S119 are the same as those of Embodiment 1.

According to Embodiment 2, the air-conditioning planning device 1 is installed inside of the building 30, and therefore, a vendor owning the air-conditioning controller 3 or an administrator of the building 30 may set an air-conditioning plan as desired using the air-conditioning planning device 1.

According to Embodiment 2, the air-conditioning planning device 1 has air-conditioning control plans for both heating and cooling as the air-conditioning control plan option, and therefore, it is possible to select the control plan for heating or the control plan for cooling depending on the conditions of the control day. As a result, an effective air-conditioning control plan can be generated.

The processing of FIG. 4 of Embodiment 1 may be conducted using the configuration of FIG. 17, and the processing of FIG. 18 of Embodiment 2 may be conducted using the configuration of FIG. 1.

### Embodiment 3

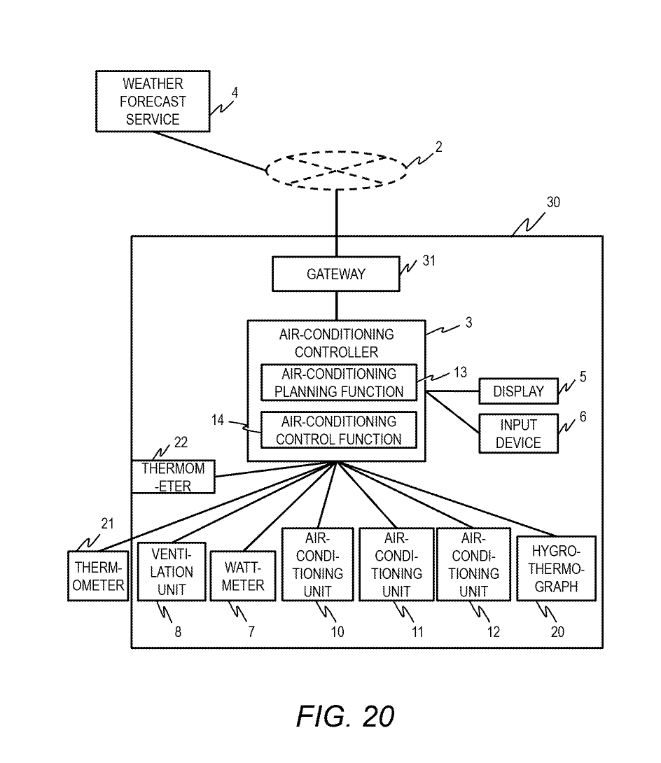

FIG. 20 is a block diagram showing an example of the device configuration and the communication network configuration of Embodiment 3.

The air-conditioning controller 3 of Embodiment 3 has an air-conditioning planning function 13 including the function of the air-conditioning planner 45 of the air-conditioning planning device 1 of Embodiment 1 and an air-conditioning control function 14 that is the air-conditioning control function of the air-conditioning controller 3 of Embodiment 1. The air-conditioning controller of Embodiment 3 is connected to a display 5 and an input device 6.

More specifically, the air-conditioning planning function 13 includes the function of the air-conditioning planner 45 shown in FIG. 2 and the function of the communication interface 43.

In order to implement the air-conditioning planning function 13, the air-conditioning controller 3 loads the air-conditioning planner 45 into the memory thereof and executes the air-conditioning planner 45. The air-conditioning controller 3 also has, in the memory thereof, the various types of data (such as the time data 46, the weather forecast data 47, the building forecast data 48, and the air-conditioning control plan option 49) of the memory 42 shown in FIG. 2.

By consolidating the air-conditioning planning function 13 and the air-conditioning control function 14, it is possible to provide a device implementing the air-conditioning planning function 13 at low cost. Also, because the air-conditioning controller 3 is directly connected to the display 5 and the input device 6, it is not necessary to install a device such as the PC 9, and it is easy to utilize the system.

The operation schedule of the air-conditioning planner 45 of Embodiment 3 is the same as the operation schedule shown in FIG. 3. The air-conditioning planner 45 of Embodiment 3 selects a plurality of air-conditioning control plans that are respectively optimal for the individual air-conditioning units. The air-conditioning planner 45 described below selects a plurality of air-conditioning control plans that are respectively optimal for the three air-conditioning units 10 to 12.

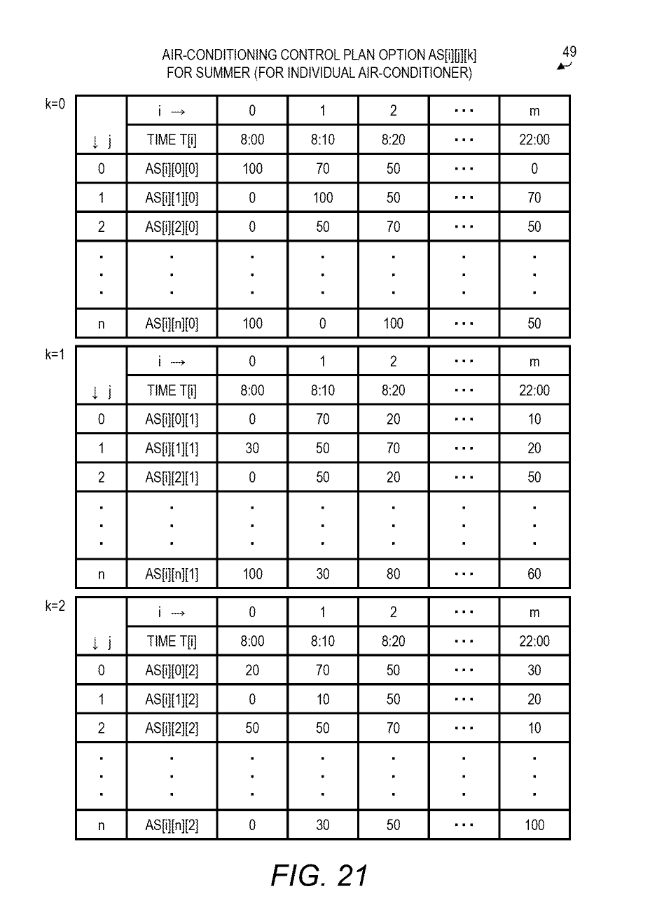

FIG. 21 is an explanatory diagram showing the air-conditioning control plan option 49 of Embodiment 3.

The air-conditioning control plan option AS[i][j][k] shown in FIG. 21 is the three-dimensional array constituted of three arrays [i][j] for the respective air-conditioning units. Each array [i][j] includes n+1 number of air-conditioning control plan options AS[i], each of which is a group of air-conditioning control settings for each time period from the time T[0] to the time T[m].

The column k stores therein a value to identify each of the three air-conditioning units 10 to 12. The air-conditioning control plan option 49 includes one column that has values each indicating the output set-point (%) of each outdoor unit, for example. By using the air-conditioning control plan option 49 for each air-conditioning unit, it is possible to generate a plan to operate some of the air-conditioning units stopping only the air-conditioning unit 11 and operating the air-conditioning unit 10 and the air-conditioning unit 12, for example.

The air-conditioning planner 45 of Embodiment 3 conducts processing similar to the processing of Embodiment 2 shown in FIG. 18 as the air-conditioning control plan generation flow. However, in Step S104, the air-conditioning planner 45 of Embodiment 3 retrieves the air-conditioning control plan options AS[i][j][k] (k is an integer of 0 to 2) shown in FIG. 21.

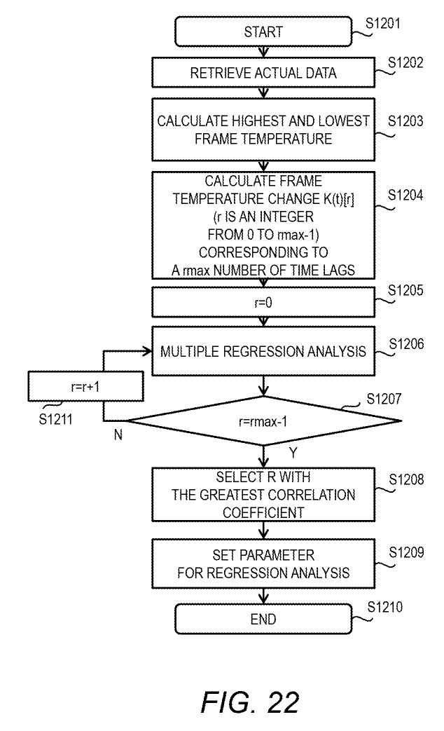

FIG. 22 is a flowchart showing in detail the processing to generate the room temperature calculation procedure 55 and the air-conditioning power usage calculation procedure 56 of Embodiment 3.

The air-conditioning planner 45 starts the processing of FIG. 22 before starting the processing of FIG. 4 or periodically (S1201) in a manner similar to Step S201 of FIG. 15. This way, the air-conditioning planner 45 can calculate the calculation parameters ax and bx (x=0 to 8), and generate the room temperature calculation procedure 55 (room temperature calculation function) and the air-conditioning power usage calculation procedure 56 (air-conditioning power usage calculation function).

In a manner similar to Step S202 of FIG. 15, the air-conditioning planner 45 retrieves the actual data of the past day and the day before the past day including the sunlight level, the outside temperature, and the room temperature (S1202) and obtains the highest frame temperature value and the lowest frame temperature value in the past data in a manner similar to Step S203 (S1203).

After S1203, the air-conditioning planner 45 obtains rmax number of possible time lags. The time lag means a time difference from the peak time of the outside temperature and relatively represents the peak time of the frame temperature. The air-conditioning planner 45 obtains possible time lags from the peak of the outside temperature as points in time at which the frame temperature possibly reaches the peak.

After Step S1203, the air-conditioning planner 45 obtains a plurality of frame temperature changes K(t)[r] using the highest frame temperature value and the lowest frame temperature value obtained in Step S1203, a sine curve, and the possible time lags (S1204). The plurality of frame temperature changes K(t)[r] are a plurality of possible frame temperature functions.

After Step S1204, the air-conditioning planner 45 generates an argument “r” representing a serial number of the time lag, and sets “r” to zero (S1205).

After Step S1205, the air-conditioning planner 45 performs multiple regression using the actual values of the outside temperature OT, the sunlight level SR, the OA equipment power usage OA, the ventilation power usage AE, the air-conditioning control plan AS, the room temperature RT, and the air-conditioning power usage AP, and the frame temperature change K(t)[r], thereby calculating the values of calculation parameters ax and bx (x=0 to 8) (S1206). This way, the room temperature calculation function and the air-conditioning power usage calculation function are derived for each possible function.

More specifically, the air-conditioning planner 45 performs multiple regression where the outside temperature OT[i−1], the sunlight level SR[i−1], the OA equipment power usage OA[i−1], the ventilation power usage AE[i−1], the frame temperature KT[i−1], the air-conditioning control plan AS[i−1], the room temperature RT, and the air-conditioning power usage AP are explanatory variables, and the room temperature RT[i] is the response variable, thereby obtaining the room temperature calculation procedure. Also the air-conditioning planner 45 performs multiple regression where the explanatory variables are the same as those of the room temperature calculation procedure, and the response variable is the air-conditioning power usage AP[i], thereby obtaining the air-conditioning power usage calculation procedure.

After Step S1206, the air-conditioning planner 45 determines whether the argument “r” is the same as (rmax−1) or not (S1207). If YES, since the room temperature calculation procedure and the air-conditioning power usage calculation procedure have been obtained by multiple regression for all of the possible functions of the time lag, the air-conditioning planner 45 conducts Step S1208.

On the other hand, if the argument “r” is not (rmax−1), in other words, if the argument “r” is smaller than (rmax−1), the air-conditioning planner 45 adds 1 to the argument “r” (S1211) and returns to Step S1206.

The air-conditioning planner 45 repeats Step S1206 and Steps S1207 and S1211 until the argument “r” is the same as rmax−1, so that “r” pairs of possible combinations of the calculation parameters ax and bx (x=0 to 8) for each of the room temperature calculation procedure and the air-conditioning power usage calculation procedure are found.

The air-conditioning planner 45 obtains a multiple correlation coefficient based on the dispersion of the actual values of the explanatory variables used in Step S1206. As a result, the multiple correlation coefficient is obtained for each of the argument “r” in the room temperature calculation procedure and the air-conditioning power usage calculation procedure. The air-conditioning planner 45 compares the obtained multiple correlation coefficients with each other, and selects the argument “r” where the multiple correlation coefficient has the greatest absolute value (S1208).

If the argument “r” with the greatest multiple correlation coefficient differs between the multiple correlation coefficient of the room temperature procedure and the multiple correlation coefficient of the air-conditioning power usage calculation procedure, the air-conditioning planner 45 may select the smaller argument “r” (or in other words, the smaller time lag) in accordance with a predetermined method. In Step S1208, the air-conditioning planner 45 may use any method as long as an argument “r” with the absolute value of the correlation coefficient being greater than a predetermined value is selected.

By Step S1208, the air-conditioning planner 45 can select a change of the frame temperature KT (frame temperature function) that matches with other actual values the most and that follows the other actual values.

After Step S1208, the air-conditioning planner 45 sets the combination of calculation parameters ax and bx (x=0 to 8) corresponding to the selected argument “r” to the coefficient of the room temperature calculation procedure and the air-conditioning power usage calculation procedure used in Steps S108 and S109 (S1209). After Step S1209, the air-conditioning planner 45 ends the processing of FIG. 22 (S1210).

In Embodiment 3, even if the time lag of the frame temperature is unknown or the time lag fluctuates depending on the season, it is possible to select a time lag with a higher degree of accuracy based on the actual values. As a result, the room temperature calculation procedure and the air-conditioning power usage calculation procedure can be set accurately, and therefore, it is possible to create an effective air-conditioning control plan.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

In the present invention, in particular, the processing of FIG. 22 of Embodiment 3 described above may be conducted by the air-conditioning planning device 1 of Embodiment 1, or the air-conditioning planning device 1 of Embodiment 1 may select an air-conditioning control plan for each of a plurality of air-conditioning units, using the air-conditioning control plan option 49 shown in FIG. 21.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

The drawings shows control lines and information lines as considered necessary for explanations but do not show all control lines or information lines in the products. It can be considered that almost of all components are actually interconnected.

What is claimed is:

1. An air-conditioning system that controls air-conditioning of a space, comprising:
an air-conditioning planning unit configured to generate a control plan for the air conditioning; and
an air-conditioning control unit configured to control the air-conditioning,
wherein the air-conditioning planning unit has a processor and a memory,
wherein the air-conditioning planning unit is connected to the air-conditioning control unit, and
wherein the air-conditioning planning unit is configured to:
obtain a plurality of air-conditioning control plan options indicating setting values for the air-conditioning at a plurality of control times at which the air-conditioning is controlled, a first room temperature of the space at a first control time included in the plurality of control times, and a first air-conditioning power usage consumed at the first control time;
store, in the memory, the plurality of air-conditioning control plan options, the first room temperature, and the first air-conditioning power usage;
calculate, for each of the options, a second room temperature at a second control time, which is a control time subsequent to the first control time, by using a room temperature calculation function whose explanatory variables include the first room temperature, the first air-conditioning power usage, and at least one of the options;
calculate, for each of the options, room temperature and air-conditioning power usage in a time series that includes the plurality of control times by calculating a second air-conditioning power usage at the second control time with an air-conditioning power usage calculation function whose explanatory variables include the first room temperature, the first air-conditioning power usage, and at least one of the options;
store the room temperature and air-conditioning power usage in a time series that includes the plurality of control times in the memory;
calculate, for each of the options, an evaluation indicator to evaluate a level of comfort and cost, based on the room temperature in a time series and the air-conditioning power usage in a time series;
select an air-conditioning control plan to be applied to the air-conditioning control unit from the plurality of options based on the evaluation indicator; and
send the selected air-conditioning control plan to the air-conditioning control unit so that the air-conditioning is controlled in accordance with the selected air-conditioning control plan.

2. The air-conditioning control system according to claim 1,
wherein the air-conditioning planning unit is configured to:
obtain actual information indicating an air-conditioning control plan executed in the space during a predetermined past period, past room temperatures of the space measured at a plurality of times during the past period in which said air-conditioning control plan was executed, and air-conditioning power usage at the plurality of times during the past period; and
conduct multiple regression calculation with the obtained actual information, thereby deriving the room temperature calculation function and the air-conditioning power usage calculation function.

3. The air-conditioning control system according to claim 2,
wherein the air-conditioning planning unit is configured to:
obtain actual information of cooling that indicates an air-conditioning control plan for cooling executed in the space during the predetermined past period, past room temperature of the space measured at a plurality of times during the past period in which the air-conditioning control plan for cooling was executed, and air-conditioning power usage at the plurality of times during the past period;
obtain actual information of heating that indicates an air-conditioning control plan for heating executed in the space during the predetermined past period, past room temperature of the space measured at a plurality of times during the past period in which the air-conditioning control plan for heating was executed, and air-conditioning power usage at the plurality of times during the past period;
conduct multiple regression calculation with the actual information for cooling, thereby deriving a room temperature calculation function and air-conditioning power usage calculation function for cooling;
conduct multiple regression calculation with the actual information for heating, thereby deriving a room temperature calculation function and air-conditioning power usage calculation function for heating; and
calculate room temperature and air-conditioning power usage in a time series that includes the plurality of control times for each of the options by using one of the room temperature calculation function and air-conditioning power usage calculation function for cooling and the room temperature calculation function and air-conditioning power usage calculation function for heating under predetermined conditions.

4. The air-conditioning control system according to claim 3,
wherein the air-conditioning planning unit is configured to:
predict room temperature by using the room temperature calculation function when the first air-conditioning power usage is zero, the first room temperature, and an air-conditioning control plan executed in the space during the predetermined past period; and
calculate, for each of the options, room temperature and air-conditioning power usage in a time series that includes the plurality of control times by using the room temperature calculation function for cooling and the air-conditioning power usage calculation function for cooling, if the predicated room temperature is equal to or greater than a predetermined target value.

5. The air-conditioning control system according to claim 1,
wherein the air-conditioning planning unit has an interface that is connected to an input device and an output device, and
wherein the air-conditioning planning unit is configured to:
output data for displaying the calculated evaluation indicator for each of the options in the output device through the interface;
obtain, from the input device through the interface, a rule applied to the evaluation indicator for selecting the air-conditioning control plan from the plurality of options; and
select an option whose evaluation indicator matches the obtained rule as an air-conditioning control plan to be applied to the air-conditioning control unit.

6. The air-conditioning control system according to claim 1,
wherein the air-conditioning planning unit sets the plurality of control times such that a time interval between two adjacent control times included in the plurality of control times becomes longer as said two control times progress.

7. The air-conditioning control system according to claim 1,
wherein the space is in contact with a frame that affects an internal environment of the space, and
wherein the air-conditioning planning unit is configured to:
obtain past outside temperature measured outside of the space during a predetermined past period;
generate a frame temperature function of the frame that changes in accordance with a change in the outside temperature and that reaches a peak after the outside temperature reaches a peak;
calculate frame temperature at each of the control times based on the frame temperature function; and
calculate, for each of the options, room temperature and air-conditioning power usage in a time series that includes the plurality of control times by using the room temperature calculation function and air-conditioning power usage calculation function that each include the frame temperature as the explanatory variable.

8. The air-conditioning control system according to claim 7,
wherein the frame temperature function is a function representing a change in the frame temperature with a sine curve of a 24-hour cycle.

9. The air-conditioning control system according to claim 7,
wherein the air-conditioning planning unit is configured to:
obtain sunlight level, outside temperature, and a highest value and a lowest value of the frame temperature during the predetermined past period;
conduct multiple regression analysis on a function including the sunlight level, outside temperature, and highest frame temperature during the predetermined past period, thereby deriving a function to obtain the highest temperature of the frame temperature function;
conduct multiple regression analysis on a function including the sunlight level, outside temperature, and lowest frame temperature during the predetermined past period, thereby deriving a function to obtain the lowest temperature of the frame temperature function; and
generate the frame temperature function by using the function to obtain the highest temperature, the function to obtain the lowest temperature, and predicted values of sunlight level and outside temperature at the plurality of control times.

10. The air-conditioning control system according to claim 7,
wherein the air-conditioning planning unit is configured to:
obtain actual information indicating an air-conditioning control plan executed in the space during the predetermined past period, outside temperature during the predetermined past period, frame temperature during the predetermined past period, past room temperatures in the space measured at a plurality of times during the past period in which said air-conditioning control plan was executed, and air-conditioning power usage at the plurality of times during the past period;
generate a plurality of frame temperature function options representing various time differences between a peak time of the outside temperature and a peak time of the frame temperature during the predetermined past period;
conduct, for each of the function options, multiple regression by using the obtained actual information, thereby deriving the room temperature calculation function and the air-conditioning power usage calculation function;
calculate a multiple correlation coefficient based on the derived room temperature calculation function and air-conditioning power usage calculation function; and
select, as the frame temperature function, one of the function options that results in the greatest multiple correlation coefficient.

11. The air-conditioning control system according to claim 7,
wherein the space includes a ventilation unit and equipment,
wherein the air-conditioning control system is connected to a weather forecast unit that provides weather forecast, and
wherein the air-conditioning planning unit is configured to:
predict sunlight level and the outside temperature at the plurality of control times based on weather information obtained from the weather forecast unit, thereby obtaining sunlight level and outside temperature at the plurality of control times;
obtain ventilation power usage consumed by the ventilation unit and equipment power usage consumed by the equipment at the plurality of control times;
calculate the second room temperature for each of the options by using a room temperature calculation function that includes the sunlight level, the outside temperature, the ventilation power usage, the equipment power usage, and the frame temperature at the first control time, the plurality of options, the first room temperature, and the first air-conditioning power usage as explanatory variables; and
calculate, for each of the options, the second air-conditioning power usage by using an air-conditioning power usage calculation function that includes the sunlight level, the outside temperature, the ventilation power usage, the equipment power usage, and the frame temperature at the first control time, the plurality of options, the first room temperature, and the first air-conditioning power usage as explanatory variables.

12. An air-conditioning planning device that generate a control plan for air conditioning, comprising:
a processor; and
a memory,
wherein the air-conditioning planning device is connected to an air-conditioning control device configured to control the air-conditioning of a space, and
wherein the air-conditioning planning device is configured to:
obtain a plurality of air-conditioning control plan options indicating setting values for the air-conditioning at a plurality of control times at which the air-conditioning is controlled, a first room temperature of the space at a first control time included in the plurality of control times, and a first air-conditioning power usage consumed at the first control time;
store, in the memory, the plurality of air-conditioning control plan options, the first room temperature, and the first air-conditioning power usage;
calculate, for each of the options, a second room temperature at a second control time, which is a control time subsequent to the first control time, by using a room temperature calculation function whose explanatory variables include the first room temperature, the first air-conditioning power usage, and at least one of the options;
calculate, for each of the options, room temperature and air-conditioning power usage in a time series that includes the plurality of control times by calculating a second air-conditioning power usage at the second control time with an air-conditioning power usage calculation function whose explanatory variables include the first room temperature, the first air-conditioning power usage, and at least one of the options;
store the room temperature and air-conditioning power usage in a time series that includes the plurality of control times in the memory;
calculate, for each of the options, an evaluation indicator to evaluate a level of comfort and cost, based on the room temperature in a time series and the air-conditioning power usage in a time series;
select an air-conditioning control plan to be applied to the air-conditioning control device from the plurality of options based on the evaluation indicator; and
send the selected air-conditioning control plan to the air-conditioning control device so that the air-conditioning is controlled in accordance with the selected air-conditioning control plan.

13. The air-conditioning planning device according to claim 12,
wherein the air-conditioning planning device is configured to:
obtain actual information indicating an air-conditioning control plan executed in the space during a predetermined past period, past room temperatures of the space measured at a plurality of times during the past period in which said air-conditioning control plan was executed, and air-conditioning power usage at the plurality of times during the past period; and
conduct multiple regression calculation with the obtained actual information, thereby deriving the room temperature calculation function and the air-conditioning power usage calculation function.

14. A planning method, by an air-conditioning planning unit, for generating a control plan for air conditioning,
wherein the air-conditioning planning unit has a processor and a memory, and
wherein the air-conditioning planning unit is connected to an air-conditioning control unit configured to control the air-conditioning of a space,
the planning method comprising:
obtaining, by the processor, a plurality of air-conditioning control plan options indicating setting values for the air-conditioning at a plurality of control times at which the air-conditioning is controlled, a first room temperature of the space at a first control time included in the plurality of control times, and a first air-conditioning power usage consumed at the first control time;
storing, by the processor, in the memory, the plurality of air-conditioning control plan options, the first room temperature, and the first air-conditioning power usage;
calculating, by the processor, for each of the options, a second room temperature at a second control time, which is a control time subsequent to the first control time, by using a room temperature calculation function whose explanatory variables include the first room temperature, the first air-conditioning power usage, and at least one of the options;
calculating, by the processor, for each of the options, room temperature and air-conditioning power usage in a time series that includes the plurality of control times by calculating a second air-conditioning power usage at the second control time with an air-conditioning power usage calculation function whose explanatory variables include the first room temperature, the first air-conditioning power usage, and at least one of the options;
storing, by the processor, the room temperature and air-conditioning power usage in a time series that includes the plurality of control times in the memory;
calculating, by the processor, for each of the options, an evaluation indicator to evaluate a level of comfort and cost, based on the room temperature in a time series and the air-conditioning power usage in a time series;
selecting, by the processor, an air-conditioning control plan to be applied to the air-conditioning control unit from the plurality of options based on the evaluation indicator; and
sending, by the processor, the selected air-conditioning control plan to the air-conditioning control unit so that the air-conditioning is controlled in accordance with the selected air-conditioning control plan.

15. The planning method according to claim 14, further comprising:
obtaining, by the processor, actual information indicating an air-conditioning control plan executed in the space during a predetermined past period, past room temperatures of the space measured at a plurality of times during the past period in which said air-conditioning control plan was executed, and air-conditioning power usage at the plurality of times during the past period; and
conducting, by the processor, multiple regression calculation with the obtained actual information, thereby deriving the room temperature calculation function and the air-conditioning power usage calculation function.
